(19) United States
(12) Patent Application Publication
(10) Pub. No.: US 2021/0058949 A1
(43) Pub. Date: Feb. 25, 2021

(54) METHOD AND DEVICE FOR TRANSMITTING AND RECEIVING WIRELESS SIGNAL IN WIRELESS COMMUNICATION SYSTEM

(71) Applicant: LG Electronics Inc., Seoul (KR)

(72) Inventors: Seonwook KIM, Seoul (KR); Hyunsoo KO, Seoul (KR); Suckchel YANG, Seoul (KR); Sukhyon YOON, Seoul (KR)

(21) Appl. No.: 17/090,500

(22) Filed: Nov. 5, 2020

Related U.S. Application Data
(63) Continuation of application No. PCT/KR2020/002645, filed on Feb. 24, 2020.

(30) Foreign Application Priority Data
Feb. 22, 2019 (KR) 10-2019-0021409
Apr. 5, 2019 (KR) 10-2019-0040392
Aug. 15, 2019 (KR) 10-2019-0099993

(51) Int. Cl. H04W 72/12

(52) U.S. Cl. CPC H04W 72/1268

(57) ABSTRACT

The present disclosure relates to a wireless communication system, and more particularly, to a method including receiving first information related to synchronization signal (SS)/physical broadcast channel (PBCH) block position, the first information being used to indicate at least one SS/PBCH block index, and performing a procedure for receiving a physical downlink shared channel (PDSCH), and an apparatus therefor.

### CROSS-REFERENCE TO RELATED APPLICATIONS

This application is a continuation of International Application No. PCT/KR2020/002645, filed on Feb. 24, 2020, which claims the benefit of Korean Application No. 10-2019-0099993, filed on Aug. 15, 2019, Korean Application No. 10-2019-0040392, filed on Apr. 5, 2019, and Korean Application No. 10-2019-0021409, filed on Feb. 22, 2019. The disclosures of the prior applications are incorporated by reference in their entirety.

### TECHNICAL FIELD

The present disclosure relates to a wireless communication system, and more particularly, to a method and apparatus for transmitting and receiving a wireless signal.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

An aspect of the present disclosure is to provide a method and apparatus for efficiently transmitting and receiving a wireless signal.

It will be appreciated by persons skilled in the art that the objects that could be achieved with the present disclosure are not limited to what has been particularly described hereinabove and the above and other objects that the present disclosure could achieve will be more clearly understood from the following detailed description.

In a first aspect of the present disclosure, a method of receiving data by a user equipment (UE) in a wireless communication system includes receiving first information related with a synchronization signal/physical broadcast channel (SS/PBCH) block position, wherein the first information is used to indicate at least one SS/PBCH block index, and performing a procedure for receiving a physical downlink shared channel (PDSCH). Based on a resource allocation of the PDSCH overlapping with SS/PBCH block transmission, the PDSCH is not received on a resource region overlapping with the SS/PBCH block transmission, each SS/PBCH block index corresponds to a plurality of candidate SS/PBCH blocks, and wherein the SS/PBCH block transmission includes all candidate SS/PBCH blocks corresponding to the at least one SS/PBCH block index according to the first information.

In a second aspect of the present disclosure, a UE used in a wireless communication system includes at least one processor, and at least one computer memory operably coupled to the at least one processor and, when executed, causing the at least one processor to perform operations. The operations include receiving first information related with SS/PBCH block position, wherein the first information is used to indicate at least one SS/PBCH block index, and performing a procedure for receiving a PDSCH. Based on a resource allocation of the PDSCH overlapping with an SS/PBCH block transmission, the PDSCH is not received on a resource region overlapping with the SS/PBCH block transmission, each SS/PBCH block index corresponds to a plurality of candidate SS/PBCH blocks, and the SS/PBCH block transmission includes all candidate SS/PBCH blocks corresponding to the at least one SS/PBCH block index according to the first information.

In a third aspect of the present disclosure, an apparatus for a UE includes at least one processor, and at least one computer memory operably coupled to the at least one processor and, when executed, causing the at least one processor to perform operations. The operations include receiving first information related with SS/PBCH block position, wherein the first information is used to indicate at least one SS/PBCH block index, and performing a procedure for receiving a PDSCH. Based on a resource allocation of the PDSCH overlapping with an SS/PBCH block transmission, the PDSCH is not received on a resource region overlapping with the SS/PBCH block transmission, each SS/PBCH block index corresponds to a plurality of candidate SS/PBCH blocks, and the SS/PBCH block transmission includes all candidate SS/PBCH blocks corresponding to the at least one SS/PBCH block index according to the first information.

In a fourth aspect of the present disclosure, a computer-readable storage medium including at least one computer program which, when executed, causes at least processor to perform operations is provided. The operations include receiving first information related with SS/PBCH block position, wherein the first information is used to indicate at least one SS/PBCH block index, and performing a procedure for receiving a PDSCH. Based on a resource allocation of the PDSCH overlapping with an SS/PBCH block transmission, the PDSCH is not received on a resource region overlapping with the SS/PBCH block transmission, each SS/PBCH block index corresponds to a plurality of candidate SS/PBCH blocks, and the SS/PBCH block transmission includes all candidate SS/PBCH blocks corresponding to the at least one SS/PBCH block index according to the first information.

In a fifth aspect of the present disclosure, a method of transmitting data by a base station (BS) in a wireless communication system includes transmitting first information related with SS/PBCH block position, wherein the first information is used to indicate at least one SS/PBCH block index, and performing a procedure for transmitting a PDSCH. Based on a resource allocation of the PDSCH overlapping with an SS/PBCH block transmission, the PDSCH is not transmitted on a resource region overlapping with the SS/PBCH block transmission, each SS/PBCH block index corresponds to a plurality of candidate SS/PBCH blocks, and the SS/PBCH block transmission includes all candidate SS/PBCH blocks corresponding to the at least one SS/PBCH block index according to the first information.

In a sixth aspect of the present disclosure, a BS used in a wireless communication system includes at least one processor, and at least one computer memory operably coupled to the at least one processor and, when executed, causing the at least one processor to perform operations. The operations include transmitting first information related with SS/PBCH block position, wherein the first information is used to indicate at least one SS/PBCH block index, and performing a procedure for transmitting a PDSCH. Based on a resource allocation of the PDSCH overlapping with an SS/PBCH block transmission, the PDSCH is not transmitted on a resource region overlapping with the SS/PBCH block transmission, each SS/PBCH block index corresponds to a plurality of candidate SS/PBCH blocks, and the SS/PBCH block transmission includes all candidate SS/PBCH blocks corresponding to the at least one SS/PBCH block index according to the first information.

Based on the resource allocation of the PDSCH not overlapping with the SS/PBCH block transmission, the PDSCH may be received/transmitted in all allocated resource region.

An SS/PBCH block may be actually transmitted only in a part of the plurality of candidate SS/PBCH blocks corresponding to each SS/PBCH block index.

The PDSCH may not be received in any resource region overlapping with the plurality of candidate SS/PBCH blocks irrespective of whether an SS/PBCH block is actually transmitted in at least one of the plurality of candidate SS/PBCH blocks.

The wireless communication system may include a wireless communication system operating in an unlicensed band.

According to the present disclosure, a wireless signal may be transmitted and received efficiently in a wireless communication system.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates physical channels used in a 3rd generation partnership project (3GPP) system as an exemplary wireless communication systems and a general signal transmission method using the same;

FIG. 2 illustrates a radio frame structure;

FIG. 3 illustrates a resource grid of a slot;

FIGS. 4 to 7 illustrate the structure/transmission of a synchronization signal block (SSB);

FIG. 8 illustrates mapping of physical channels in a slot;

FIG. 9 illustrates an acknowledgment/negative acknowledgement (ACK/NACK) transmission process;

FIG. 10 illustrates a physical uplink shared channel (PUSCH) transmission process;

FIGS. 11A and 11B illustrate a wireless communication system supporting an unlicensed band;

FIG. 12 illustrates a method of occupying resources in an unlicensed band;

FIG. 13 illustrates physical downlink shared channel (PDSCH) resources;

FIGS. 14 and 15 illustrate SSB time patterns;

FIGS. 16 and 17 illustrate a plurality of candidate SSBs;

FIGS. 18 and 19 illustrate PDSCH reception/transmission according to an example of the present disclosure;

FIGS. 20 to 24 illustrate PDSCH mapping according to an example of the present disclosure;

FIGS. 25, 26 and 27 illustrate PDSCH processing times according to an example of the present disclosure; and

FIGS. 28 to 31 illustrate a communication system 1 and wireless devices, which are applied to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive machine type communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and ultra-reliable and low latency communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

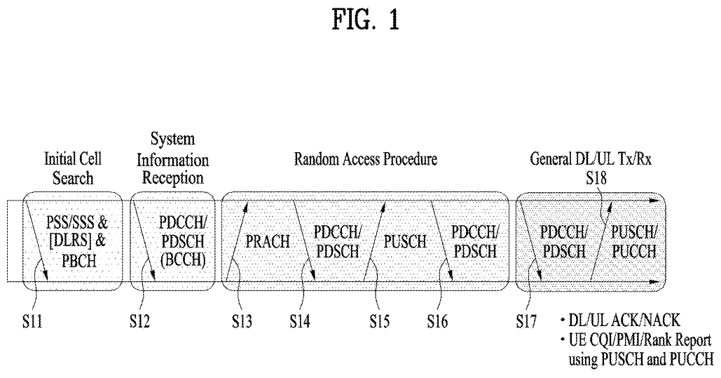

FIG. 1 illustrates physical channels used in a 3GPP NR system and a general signal transmission method using the same.

When powered on or when a UE initially enters a cell, the UE performs initial cell search involving synchronization with a BS in step S101. For initial cell search, the UE receives synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

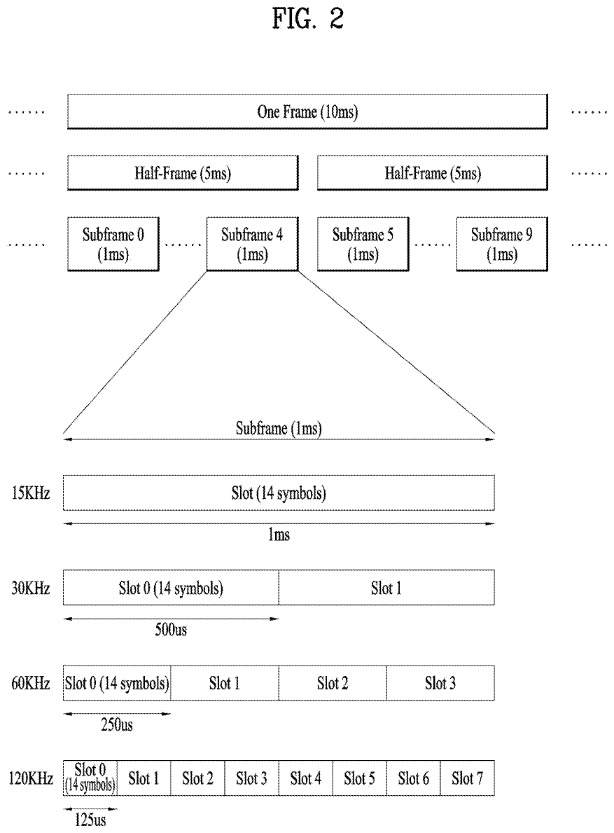

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 orthogonal frequency division multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame, u}ₛₗₒₜ: Number of slots in a frame
* N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example. The number of subframes, the number of slots, and the number of symbols in a frame may vary.

In the NR system, different OFDM numerologies (e.g., SCSs) may be configured for a plurality of cells aggregated for one UE. Accordingly, the (absolute time) duration of a time resource including the same number of symbols (e.g., a subframe (SF), slot, or TTI) (collectively referred to as a time unit (TU) for convenience) may be configured to be different for the aggregated cells. A symbol may be an OFDM symbol (or CP-OFDM symbol) or an SC_FDMA symbol (or a discrete Fourier transform-spread-OFDM (DFT-s-OFDM) symbol).

In NR, various numerologies (or SCSs) are supported to support various 5G services. For example, with an SCS of 15 kHz, a wide area in traditional cellular bands is supported, while with an SCS of 30 kHz/60 kHz, a dense urban area, a lower latency, and a wide carrier bandwidth are supported. With an SCS of 60 kHz or higher, a bandwidth larger than 24.25 GHz is be supported to overcome phase noise.

An NR frequency band may be defined by two types of frequency ranges, FR1 and FR2. FR1 and FR2 may be configured as described in Table 3. FR2 may refer to millimeter wave (mmW).

TABLE 3

| Frequency Range | Corresponding | |
|---|---|---|
| designation | frequency range | Subcarrier Spacing |
| FR1 | 450 MHz-7125 MHz | 15, 30, 60 kHz |
| FR2 | 24250 MHz-52600 MHz | 60, 120, 240 kHz |

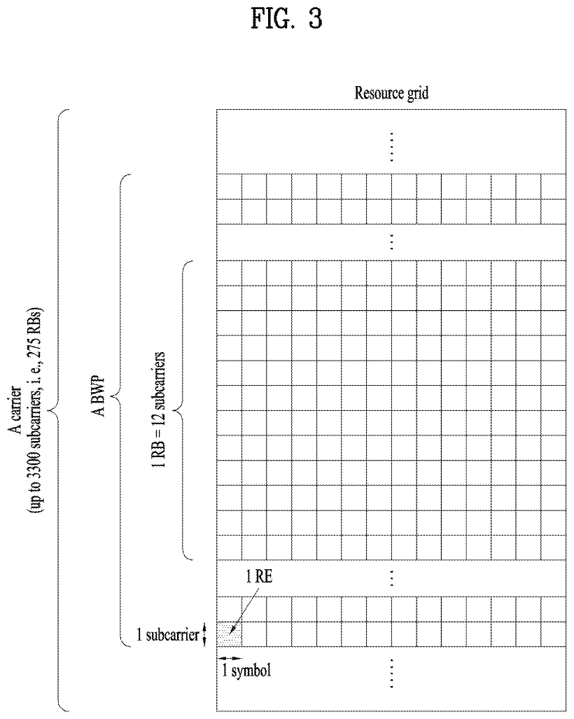

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

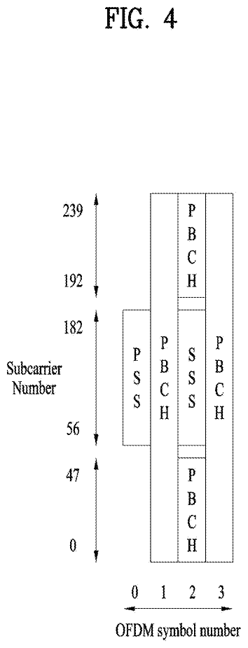

FIG. 4 illustrates the structure of an SSB. A UE may perform cell search, system information acquisition, beam alignment for initial access, DL measurement, and so on based on an SSB. The term SSB is interchangeably used with an SS/PBCH block. The SSB is made up of four consecutive OFDM symbols, each carrying a PSS, a PBCH, an SSS/PBCH, or a PBCH. Each of the PSS and the SSS includes one OFDM symbol by 127 subcarriers, and the PBCH includes 3 OFDM symbols by 576 subcarriers. Polar coding and quadrature phase shift keying (QPSK) are applied to the PBCH. The PBCH includes data REs and demodulation reference signal (DMRS) REs in each OFDM symbol. There are three DMRS REs per RB, and three data REs exist between DMRS REs.

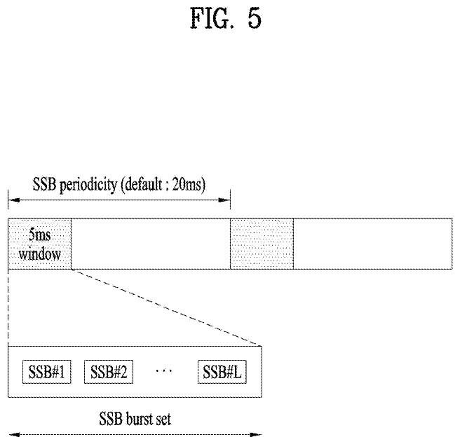

FIG. 5 illustrates exemplary SSB transmission. Referring to FIG. 5, an SSB is transmitted periodically according to an SSB periodicity. A default SSB periodicity that the UE assumes during initial cell search is defined as 20 ms. After cell access, the SSB periodicity may be set to one of {5 ms, 10 ms, 20 ms, 40 ms, 80 ms, 160 ms} by a network (e.g., a BS). An SSB burst set is configured at the start of an SSB period. The SSB burst set includes a 5-ms time window (i.e., a half-frame), and an SSB may be transmitted up to L times in the SSB burst set. The maximum transmission number L of an SSB may be given as follows according to the frequency band of a carrier. One slot includes up to two SSBs.
For frequency range of up to 3 GHz, L=4
For frequency range from 3 GHz to 6 GHz, L=8
For frequency range from 6 GHz to 52.6 GHz, L=64

The time positions of SSB candidates in an SS burst set may be defined as follows according to SCSs. The time positions of SSB candidates are indexed with (SSB indexes) 0 to L−1 in time order in the SSB burst set (i.e., half-frame).
Case A—15-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case B—30-kHz SCS: The indexes of the first symbols of candidate SSBs are given as {4, 8, 16, 20}+28*n where n=0 for a carrier frequency equal to or lower than 3 GHz, and n=0, 1 for a carrier frequency of 3 GHz to 6 GHz.
Case C—30-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case D—120-kHz SCS: The indexes of the first symbols of candidate SSBs are given as {4, 8, 16, 20}+28*n where n=0, 1, 2, 3, 5, 6, 7, 8, 10, 11, 12, 13, 15, 16, 17, 18 fora carrier frequency above 6 GHz.
Case E—240-kHz SCS: The indexes of the first symbols of candidate SSBs are given as {8, 12, 16, 20, 32, 36, 40, 44}+56*n where n=0, 1, 2, 3, 5, 6, 7, 8 for a carrier frequency above 6 GHz.

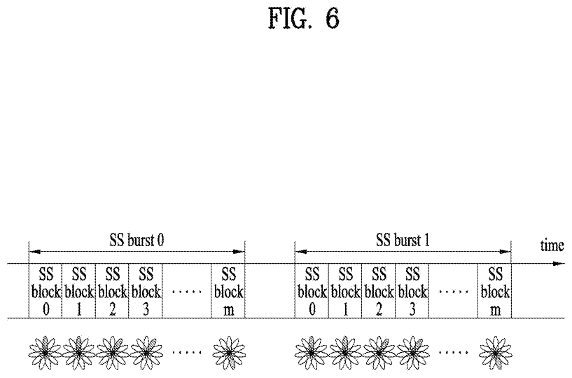

FIG. 6 illustrates exemplary multi-beam transmission of SSBs. Beam sweeping refers to changing the beam (direction) of a wireless signal over time at a transmission reception point (TRP) (e.g., a BS/cell) (hereinbelow, the terms beam and beam direction are interchangeably used). An SSB may be transmitted periodically by beam sweeping. In this case, SSB indexes are implicitly linked to SSB beams. An SSB beam may be changed on an SSB (index) basis. The maximum transmission number L of an SSB in an SSB burst set is 4, 8 or 64 according to the frequency band of a carrier. Accordingly, the maximum number of SSB beams in the SSB burst set may be given according to the frequency band of a carrier as follows.
For frequency range of up to 3 GHz, Max number of beams=4

For frequency range from 3 GHz to 6 GHz, Max number of beams=8
For frequency range from 6 GHz to 52.6 GHz, Max number of beams=64

*Without multi-beam transmission, the number of SSB beams is 1.

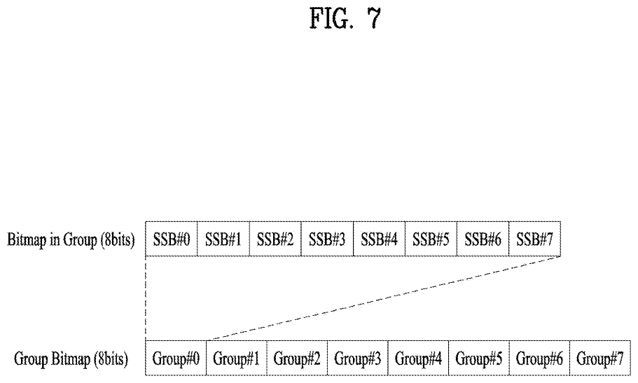

FIG. 7 illustrates an exemplary method of indicating an actually transmitted SSB, SSB_tx. Up to L SSBs may be transmitted in an SSB burst set, and the number/positions of actually transmitted SSBs may be different for each BS/cell. The number/positions of actually transmitted SSBs are used for rate-matching and measurement, and information about actually transmitted SSBs is indicated as follows.
If the information is related to rate-matching, the information may be indicated by UE-specific RRC signaling or remaining minimum system information (RMSI). The UE-specific RRC signaling includes a full bitmap (e.g., of length L) for frequency ranges below and above 6 GHz. The RMSI includes a full bitmap for a frequency range below 6 GHz and a compressed bitmap for a frequency range above 6 GHz, as illustrated in FIG. 7. Specifically, the information about actually transmitted SSBs may be indicated by a group-bitmap (8 bits)+an in-group bitmap (8 bits). Resources (e.g., REs) indicated by the UE-specific RRC signaling or the RMSI may be reserved for SSB transmission, and a PDSCH/PUSCH may be rate-matched in consideration of the SSB resources.
If the information is related to measurement, the network (e.g., BS) may indicate an SSB set to be measured within a measurement period, when the UE is in RRC connected mode. The SSB set may be indicated for each frequency layer. Without an indication of an SSB set, a default SSB set is used. The default SSB set includes all SSBs within the measurement period. An SSB set may be indicated by a full bitmap (e.g., of length L) in RRC signaling. When the UE is in RRC idle mode, the default SSB set is used.

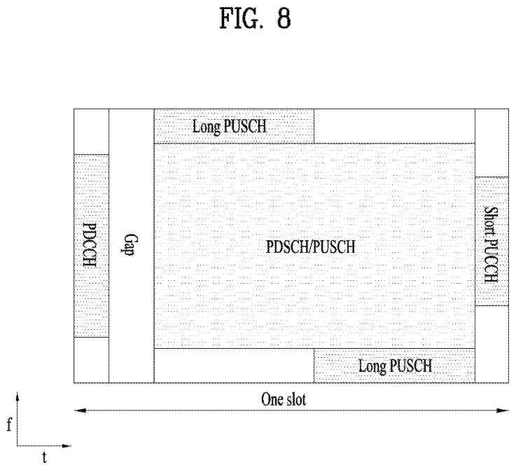

FIG. 8 illustrates exemplary mapping of physical channels in a slot. In the NR system, a frame is characterized by a self-contained structure in which all of a DL control channel, DL or UL data, and a UL control channel may be included in one slot. For example, the first N symbols of a slot may be used for a DL control channel (e.g., PDCCH) (hereinafter, referred to as a DL control region), and the last M symbols of the slot may be used for a UL control channel (e.g., PUCCH) (hereinafter, referred to as a UL control region). Each of N and M is an integer equal to or larger than 0. A resource area (referred to as a data region) between the DL control region and the UL control region may be used for transmission of DL data (e.g., PDSCH) or UL data (e.g., PUSCH). A guard period (GP) provides a time gap for switching between a transmission mode and a reception mode at the BS and the UE. Some symbol at the time of switching from DL to UL may be configured as a GP.

The PDCCH carries downlink control information (DCI). For example, the PCCCH (i.e., DCI) carries a transmission format and resource allocation of a downlink shared channel (DL-SCH), resource allocation information about an uplink shared channel (UL-SCH), paging information about a paging channel (PCH), system information present on the DL-SCH, resource allocation information about a higher layer control message such as a random access response transmitted on a PDSCH, a transmit power control command, and activation/release of configured scheduling (CS). The DCI includes a cyclic redundancy check (CRC). The CRC is masked/scrambled with different identifiers (e.g., radio network temporary identifier (RNTI)) according to the owner or usage of the PDCCH. For example, if the PDCCH is for a specific UE, the CRC will be masked with a UE identifier (e.g., cell-RNTI (C-RNTI)). If the PDCCH is for paging, the CRC will be masked with a paging-RNTI (P-RNTI). If the PDCCH is for system information (e.g., a system information block (SIB)), the CRC will be masked with a system information RNTI (SI-RNTI). If the PDCCH is for a random access response, the CRC will be masked with a random access-RNTI (RA-RNTI).

The PUCCH carries uplink control information (UCI). The UCI includes the following information.
Scheduling Request (SR): Information that is used to request a UL-SCH resource.
Hybrid Automatic Repeat Request (HARQ)-Acknowledgment (ACK): A response to a downlink data packet (e.g., codeword) on the PDSCH. HARQ-ACK indicates whether the downlink data packet has been successfully received. In response to a single codeword, one bit of HARQ-ACK may be transmitted. In response to two codewords, two bits of HARQ-ACK may be transmitted. The HARQ-ACK response includes positive ACK (simply, ACK), negative ACK (NACK), DTX or NACK/DTX. Here, the HARQ-ACK is used interchangeably used with HARQ ACK/NACK and ACK/NACK.
Channel State Information (CSI): Feedback information about a downlink channel. Multiple input multiple output (MIMO)-related feedback information includes a rank indicator (RI) and a precoding matrix indicator (PMI).

Table 4 exemplarily shows PUCCH formats. PUCCH formats may be divided into short PUCCHs (Formats 0 and 2) and long PUCCHs (Formats 1, 3, and 4) based on the PUCCH transmission duration.

TABLE 4

| | Length in | | | |
|---|---|---|---|---|
| | OFDM | Number | | |
| PUCCH | symbols | of | | |
| format | N^{PUCCH}_{symb} | bits | Usage | Etc |
| 0 | 1-2 | ≤2 | HARQ, SR | Sequence |
| | | | | selection |
| 1 | 4-14 | ≤2 | HARQ, [SR] | Sequence |
| | | | | modulation |
| 2 | 1-2 | >2 | HARQ, CSI, [SR] | CP-OFDM |
| 3 | 4-14 | >2 | HARQ, CSI, [SR] | DFT-s-OFDM |
| | | | | (no UE multi- |
| | | | | plexing) |
| 4 | 4-14 | >2 | HARQ, CSI, [SR] | DFT-s-OFDM |
| | | | | (Pre DFT OCC) |

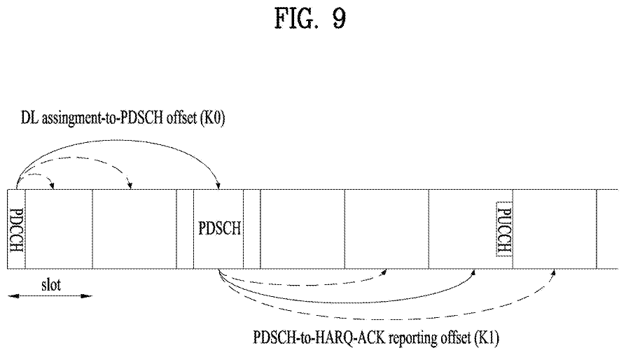

FIG. 9 illustrates an ACK/NACK transmission procedure. Referring to FIG. 9, the UE may detect a PDCCH in slot #n. Here, the PDCCH includes downlink scheduling information (e.g., DCI format 1_0 or 1_1). The PDCCH indicates a DL assignment-to-PDSCH offset (K0) and a PDSCH-HARQ-ACK reporting offset (K1). For example, DCI format 1_0 or 1_1 may include the following information.
Frequency domain resource assignment (FDRA): Indicates an RB set assigned to the PDSCH.
Time domain resource assignment (TDRA): Indicates K0 and the starting position (e.g. OFDM symbol index) and duration (e.g. the number of OFDM symbols) of the PDSCH in a slot. TDRA may be indicated by a start and length indicator value (SLIV).
PDSCH-to-HARQ_feedback timing indicator: Indicates K1.
HARQ process number (4 bits): Indicates an HARQ process identify (ID) for data (e.g., PDSCH or TB).
PUCCH resource indicator (PRI): Indicates PUCCH resources to be used for UCI transmission among a plurality of resources in a PUCCH resource set.

After receiving the PDSCH in slot #(n+K0) according to the scheduling information of slot #n, the UE may transmit UCI on the PUCCH in slot #(n+K1). Here, the UCI includes a HARQ-ACK response to the PDSCH. In the case where the PDSCH is configured to transmit a maximum of one TB, the HARQ-ACK response may be configured in one bit. In the case where the PDSCH is configured to transmit a maximum of two TBs, the HARQ-ACK response may be configured in two bits if spatial bundling is not configured and may be configured in one bit if spatial bundling is configured. When slot #(n+K1) is designated as a HARQ-ACK transmission time for a plurality of PDSCHs, the UCI transmitted in slot #(n+K1) includes HARQ-ACK responses to the plurality of PDSCHs.

A minimum processing time T_{proc,1} to be ensured for the UE to transmit an HARQ-ACK for a received PDSCH may be defined as described in Table 5.

TABLE 5
UE PDSCH processing procedure time

If the first uplink symbol of the PUCCH which carries the HARQ-ACK information, as
defined by the assigned HARQ-ACK timing K₁ and the PUCCH resource to be used
and including the effect of the timing advance, starts no earlier than at symbol L₁,
where L₁ is defined as the next uplink symbol with its CP starting after
T_{proc, 1} = (N₁ + d_{1, 1})(2048 + 144)*2^{-u}*Tₛ after the end of the last symbol of the PDSCH
carrying the TB being acknowledged, then the UE shall provide a valid HARQ-ACK
message.
N₁ is based on μ for UE processing capability 1 and 2 respectively, where μ
corresponds to the one of (μ_{PDCCH}, μ_{PDSCH}, μ_{UL}) resulting with the largest T_{proc, 1}, where
the μ_{PDCCH} corresponds to the subcarrier spacing of the PDCCH scheduling the
PDSCH, the μ_{PDSCH} corresponds to the subcarrier spacing of the scheduled PDSCH, and
μ_{UL} corresponds to the subcarrier spacing of the uplink channel with which the HARQ-
ACK is to be transmitted, and Tₛ is defined as 1/(15000*2048) (sec).
If the PDSCH DM-RS position 1₁ for the additional DM-RS is 1₁ = 12 then N_{1, 0} = 14,
otherwise N_{1, 0} = 13.
For the PDSCH mapping type A: if the last symbol of PDSCH is on the i-th symbol of
the symbol where i < 7, then d_{1, 1} = 7 − i, otherwise d_{1, 1} = 0
For UE processing capability 1: If the PDSCH is mapping B, and
if the number of PDSCH symbols allocated is 7, then d_{1, 1} = 0,
if the number of PDSCH symbols allocated is 4, then d_{1, 1} = 3
if the number of PDSCH symbols allocated is 2, then d_{1, 1} = 3 + d, where d is the
number of overlapping symbols of the scheduling PDCCH and the scheduled PDSCH.
For UE processing capability 2: If the PDSCH is mapping type B,
if the number of PDSCH symbols allocated is 7, then d_{1, 1} = 0,
if the number of PDSCH symbols allocated is 4, then d_{1, 1} is the number of
overlapping symbols of the scheduling PDCCH and the scheduled PDSCH,
if the number of PDSCH symbols allocated is 2,
if the scheduling PDCCH was in a 3-symbol CORESET and the CORESET and the
PDSCH had the same starting symbol, then d_{1, 1} = 3,
otherwise d_{1, 1} is the number of overlapping symbols of the scheduling PDCCH and
the scheduled PDSCH.
Otherwise the UE may not provide a valid HARQ-ACK corresponding to the
scheduled PDSCH. The value of T_{proc, 1} is used both in the case of normal and extended
cyclic prefix.

Table 6 specifies an N₁ value according to u, for UE processing capability 1, and Table 7 specifies an N₁ value according to u, for UE processing capability 1.

TABLE 6

PDSCH decoding time N₁ [symbols]

| | | dmrs-AdditionalPosition ≠ |
|---|---|---|
| | | pos0 or if the higher layer |
| | dmrs-AdditionalPosition = | parameter is not configured |
| u | pos0 (see, table 9) | (see, table 9) |
| 0 | 8 | N_{1, 0} |
| | | (If the PDSCH DM-RS |
| | | position 1₁ for the |
| | | additional DM-RS is |
| | | 1₁ = 12 then N_{1, 0} = 14, |
| | | otherwise N_{1, 0} = 13) |
| 1 | 10 | 13 |
| 2 | 17 | 20 |
| 3 | 20 | 24 |

TABLE 7

| | PDSCH decoding time N₁ [symbols] |
|---|---|
| u | dmrs-AdditionalPosition = pos0 (see, table 9) |
| 0 | 3 |
| 1 | 4.5 |
| 2 | 9 for frequency range 1 |

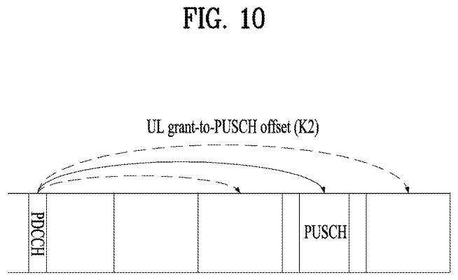

FIG. 10 illustrates an exemplary PUSCH transmission procedure. Referring to FIG. 10, a UE may detect a PDCCH in slot #n. The PDCCH may include UL scheduling information (e.g., DCI format 0_0, DCI format 0_1). DCI format 0_0 and DCI format 0_1 may include the following information.
FDRA: this indicates an RB set allocated to a PUSCH.
TDRA: this specifies a slot offset K2 indicating the starting position (e.g., symbol index) and length (e.g., the number of OFDM symbols) of the PUSCH in a slot. The starting symbol and length of the PUSCH may be indicated by a SLIV, or separately.

The UE may then transmit the PUSCH in slot #(n+K2) according to the scheduling information in slot #n. The PUSCH includes a UL-SCH TB. When the PUCCH transmission time overlaps with the PUSCH transmission time, UCI may be transmitted on the PUSCH (PUSCH piggyback).

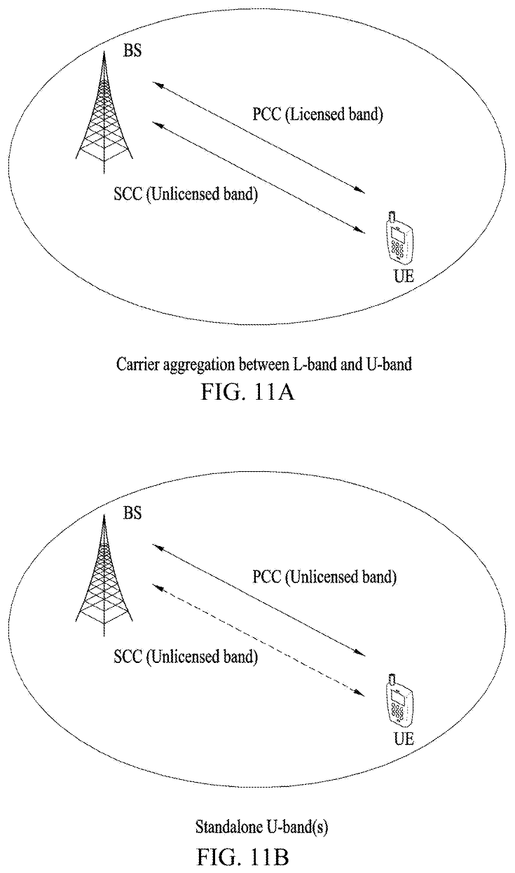

FIGS. 11A and 11B illustrate a wireless communication system supporting an unlicensed band. For the convenience of description, a cell operating in a licensed band (hereinafter, referred to as L-band) is defined as an LCell, and a carrier of the LCell is defined as a (DL/UL) licensed component carrier (LCC). In addition, a cell operating in an unlicensed band (hereinafter, referred to as a U-band) is defined as a UCell, and a carrier of the UCell is defined as a (DL/UL) unlicensed component carrier (UCC). The carrier of a cell may refer to the operating frequency (e.g., center frequency) of the cell. A cell/carrier (e.g., CC) may be collectively referred to as a cell.

When carrier aggregation (CA) is supported, one UE may transmit and receive signals to and from a BS in a plurality of cells/carriers. When a plurality of CCs are configured for one UE, one CC may be configured as a primary CC (PCC) and the other CCs may be configured as secondary CCs (SCCs). Specific control information/channel (e.g., CSS PDCCH or PUCCH) may be configured to be transmitted and received only on the PCC. Data may be transmitted in the PCC/SCC. FIG. 11A illustrates signal transmission and reception between a UE and a BS in an LCC and a UCC (non-standalone (NSA) mode). In this case, the LCC may be configured as a PCC, and the UCC may be configured as an SCC. When a plurality of LCCs are configured for the UE, one specific LCC may be configured as a PCC, and the remaining LCCs may be configured as SCCs. FIG. 11A corresponds to LAA of a 3GPP LTE system. FIG. 11B illustrates signal transmission and reception between a UE and a BS in one or more UCCs without any LCC (SA mode). In this case, one of the UCCs may be configured as a PCC, and the remaining UCCs may be configured as SCCs. Both the NSA mode and the SA mode may be supported in the unlicensed band of the 3GPP NR system.

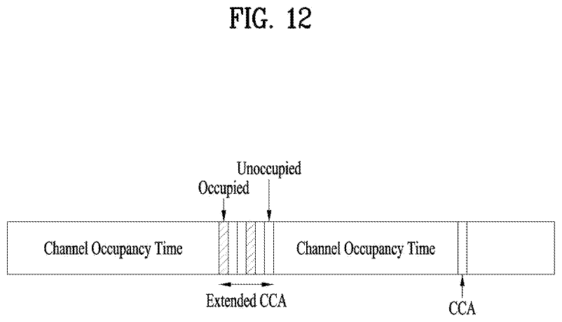

FIG. 12 illustrates an exemplary method of occupying resources in an unlicensed band. According to regional regulations for an unlicensed band, a communication node should determine whether other communication node(s) is using a channel in the unlicensed band, before signal transmission. Specifically, the communication node may determine whether other communication node(s) is using a channel by performing carrier sensing (CS) before signal transmission. When the communication node confirms that any other communication node is not transmitting a signal, this is defined as confirming clear channel assessment (CCA). In the presence of a CCA threshold predefined by higher-layer signaling (RRC signaling), when the communication node detects energy higher than the CCA threshold in the channel, the communication node may determine that the channel is busy, and otherwise, the communication node may determine that the channel is idle. For reference, the WiFi standard (e.g., 801.11ac) specifies a CCA threshold of −62 dBm for a non-WiFi signal and a CCA threshold of −82 dBm for a WiFi signal. When determining that the channel is idle, the communication node may start signal transmission in a UCell. The above-described series of operations may be referred to as a listen-before-talk (LBT) or channel access procedure (CAP). LBT and CAP may be interchangeably used.

In Europe, two LBT operations are defined: frame based equipment (FBE) and load based equipment (LBE). In FBE, one fixed frame is made up of a channel occupancy time (e.g., 1 to 10 ms), which is a time period during which once a communication node succeeds in channel access, the communication node may continue transmission, and an idle period corresponding to at least 5% of the channel occupancy time, and CCA is defined as an operation of observing a channel during a CCA slot (at least 20us) at the end of the idle period. The communication node performs CCA periodically on a fixed frame basis. When the channel is unoccupied, the communication node transmits during the channel occupancy time, whereas when the channel is occupied, the communication node defers the transmission and waits until a CCA slot in the next period.

In LBE, the communication node may set q∈{4, 5, . . . , 32} and then perform CCA for one CCA slot. When the channel is unoccupied in the first CCA slot, the communication node may secure a time period of up to (13/32)q ms and transmit data in the time period. When the channel is occupied in the first CCA slot, the communication node randomly selects N∈{1, 2, . . . , q}, stores the selected value as an initial value, and then senses a channel state on a CCA slot basis. Each time the channel is unoccupied in a CCA slot, the communication node decrements the stored counter value by 1. When the counter value reaches 0, the communication node may secure a time period of up to (13/32)q ms and transmit data.

### Embodiments

In an unlicensed-band NR system, when a CAP is successful, a signal may be transmitted by occupying a channel. Therefore, in case a CAP is failed, multiple transmission occasions may be assigned to an essential signal required for initial access and/or radio resource management (RRM)/radio link management (RLM) measurement, such as an SSB. For example, 20 SSB transmission occasions may be defined in a 5-ms window (e.g., 10 slots for a 30-kHz SCS) and an SSB may be transmitted from a time when a CAP is successful, thereby increasing a transmission probability. In this manner, a BS may transmit a signal more stably to a UE attempting initial access or performing measurement. However, for a DL signal to be transmitted in the same slot or window as an SSB, a DL transmission area may be interpreted/indicated differently depending on whether the SSB is transmitted in the slot carrying the DL signal.

Therefore, the present disclosure proposes a method of allocating resources to a DL signal (e.g., PDSCH) (transmittable in the same slot as an SSB), a method of indicating/identifying whether an SSB is transmitted, and a method of mapping DL data depending on whether an SSB is transmitted.

Further, when it is said that “an SSB corresponds to or is associated with a CORESET/PDCCH”, this may imply that “the SSB and the CORESET/PDCCH are transmitted on the same beam”, “a UE receiving the SSB and the CORESET/PDCCH assumes the same Rx filter”, “the SSB and the CORESET/PDCCH are in a quasi co-location (QCL) relationship”, or “the SSB or a DL signal using the SSB as a QCL source is defined according to the transmission configuration indicator (TCI) state of the CORESET”.

Section 1: PDSCH Time Domain Resource Allocation (TDRA) Method

Before receiving UE-specific RRC signaling related to an SLIV, a UE may check PDSCH TDRA by using default parameters. For example, if the RNTI of a PDCCH is an SI-RNTI used to receive SIB1 or RMSI, and SSB/CORESET multiplexing pattern 1 is given (for reference, only pattern 1 is allowed for FR1), the TDRA of a PDSCH scheduled by the PDCCH is based on a default parameter set listed in Table 8.

TABLE 8

| | dmrs- | PDSCH | | | |
|---|---|---|---|---|---|
| | TypeA- | mapping | | | |
| Row index | Position | type | K₀ | S | L |
| 1 | 2 | Type A | 0 | 2 | 12 |
| | 3 | Type A | 0 | 3 | 11 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2, 3 | Type B | 0 | 5 | 7 |
| 9 | 2, 3 | Type B | 0 | 5 | 2 |
| 10 | 2, 3 | Type B | 0 | 9 | 2 |
| 11 | 2, 3 | Type B | 0 | 12 | 2 |
| 12 | 2, 3 | Type A | 0 | 1 | 13 |
| 13 | 2, 3 | Type A | 0 | 1 | 6 |
| 14 | 2, 3 | Type A | 0 | 2 | 4 |
| 15 | 2, 3 | Type B | 0 | 4 | 7 |
| 16 | 2, 3 | Type B | 0 | 8 | 4 |

In Table 8, dmrs-TypeA-position may be signaled by a PBCH. When dmrs-TypeA-position=2,3, this indicates that the first DMRS symbol in PDSCH mapping type A is the third and fourth symbols of a slot, respectively. In PDSCH mapping type B, the first symbol of the PDSCH is basically a DMRS symbol. K₀ represents a slot offset from a slot carrying a PDCCH to a slot carrying a PDSCH. That is, when K₀=0, this indicates that the PDSCH and the PDCCH scheduling the PDSCH are located in the same slot. S represents the index of the starting symbol of the PDSCH in a slot, and L represents the number of (consecutive) symbols in the PDSCH.

An additional DMRS may be transmitted according to the value of L, and the positions of DMRS transmission symbols may be determined according to a PDSCH mapping type, the index of a starting symbol, and the number of symbols, as described in Table 9.

TABLE 9

| | DM-RS positions lᵣ | | | | | | | |
|---|---|---|---|---|---|---|---|---|
| | PDSCH mapping type A | | | | PDSCH mapping type B | | | |
| l_{d} in | dmrs-AdditionalPosition | | | | dmrs-AdditionalPosition | | | |
| symbols | 0 | 1 | 2 | 3 | 0 | 1 | 2 | 3 |

| | | | | | | |
|---|---|---|---|---|---|---|
| 2 | — | — | — | — | l₀ | l₀ |
| 3 | l₀ | l₀ | l₀ | l₀ | — | — |
| 4 | l₀ | l₀ | l₀ | l₀ | l₀ | l₀ |
| 5 | l₀ | l₀ | l₀ | l₀ | — | — |
| 6 | l₀ | l₀ | l₀ | l₀ | l₀ | l₀, 4 |
| 7 | l₀ | l₀ | l₀ | l₀ | l₀ | l₀, 4 |
| 8 | l₀ | l₀, 7 | l₀, 7 | l₀, 7 | — | — |
| 9 | l₀ | l₀, 7 | l₀, 7 | l₀, 7 | — | — |
| 10 | l₀ | l₀, 9 | l₀, 6, 9 | l₀, 6, 9 | — | — |
| 11 | l₀ | l₀, 9 | l₀, 6, 9 | l₀, 6, 9 | — | — |
| 12 | l₀ | l₀, 9 | l₀, 6, 9 | l₀, 5, 8, 11 | — | — |
| 13 | l₀ | l₀, 1₁ | l₀, 7, 11 | l₀, 5, 8, 11 | — | — |
| 14 | l₀ | l₀, 1₁ | l₀, 7, 11 | l₀, 5, 8, 11 | — | — |

I_{d} may represent the position of the ending symbol of a PDSCH in a slot in PDSCH mapping type A, and the number of symbols in the PDSCH in PDSCH mapping type B. l₀ may represent the value of dmrs-TypeA-position in PDSCH mapping type A and may be 0 in PDSCH mapping type B. lᵣ may represent the index of a symbol in the slot in PDSCH mapping type A, and a relative symbol index with respect to the starting symbol index of the PDSCH in PDSCH mapping type B (e.g., lᵣ is 0 for the starting symbol index). In PDSCH mapping type B, when a CORESET overlaps with the position of a DMRS transmission symbol, the position of the DMRS transmission symbol may be shifted to the symbol next to the last symbol of the CORESET.

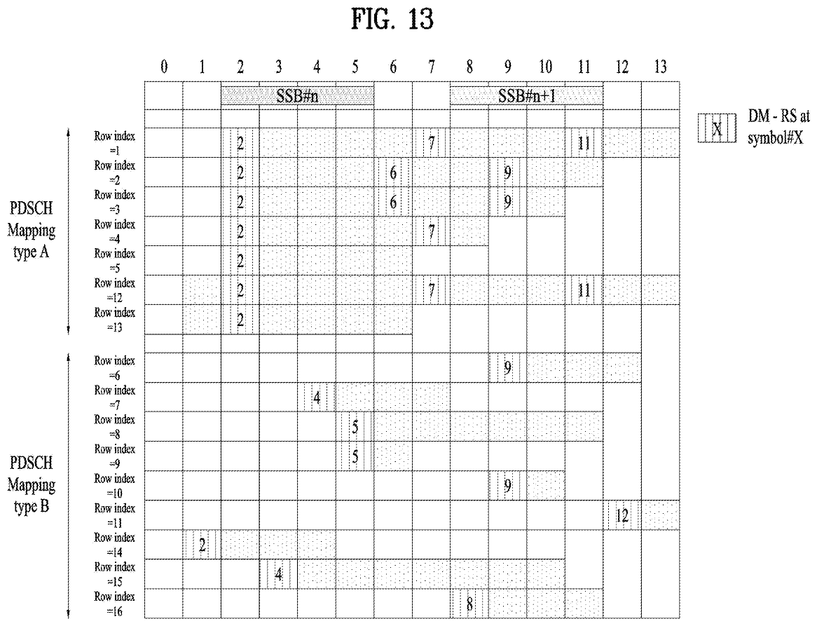

Based on the above description, when dmrs-TypeA-position is set to 2, TDRA results and the positions of DMRS symbols for the respective row indexes listed in Table 8 are illustrated in FIG. 13.

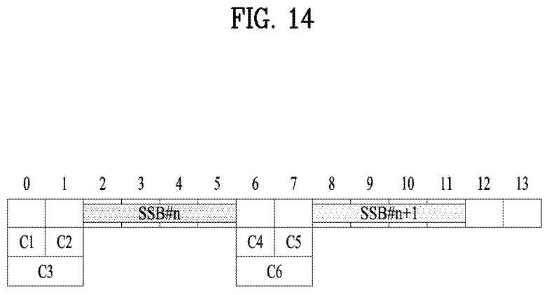

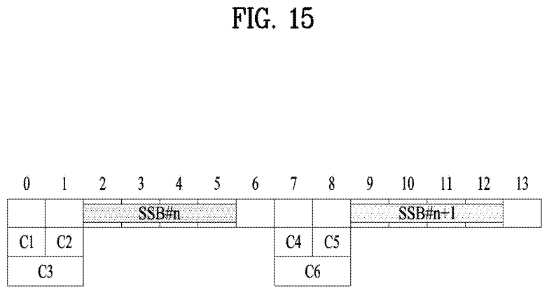

When two SSBs are transmittable in a slot as illustrated in FIG. 14, a CORESET corresponding to SSB #n may be configured as a 1-symbol CORESET C1 and/or C2 in symbol #0 and/or symbol #1 and/or a 2-symbol CORESET C3 in symbols #0 and #1. Further, a CORESET corresponding to SSB #n+1 may be configured as a 1-symbol CORESET C4 and/or C5 in symbol #6 and/or symbol #7 and/or a 2-symbol CORESET C6 in symbols #6 and #7. SSB transmissions illustrated in FIG. 15 may be supported for symmetry between half-slots by modifying FIG. 14. A CORESET corresponding to SSB #n may be configured as a 1-symbol CORESET C1 and/or C2 in symbol #0 and/or symbol #1 and/or a 2-symbol CORESET C3 in symbols #0 and #1. Further, a CORESET corresponding to SSB #n+1 may be configured as a 1-symbol CORESET C4 and/or C5 in symbol #7 and/or symbol #8 and/or a 2-symbol CORESET C6 in symbols #7 and #8.

If two candidate positions (i.e., two candidate symbols) are configured for a 1-symbol CORESET, even though a CAP is failed in a first symbol, probable success of the CAP in the next symbol may lead to transmission of a PDCCH and a scheduled PDSCH.

When a CORESET is multiplexed in TDM with a PDSCH scheduled by a PDCCH in the CORESET, it may be preferable to schedule the PDSCH without a gap between the PDCCH and the PDSCH because the BS may have to perform an additional CAP in the presence of the gap. Further, to transmit a PDCCH within a CORESET, a PDSCH, and/or an SSB successively to the PDSCH, it is preferable to schedule the PDSCH without a gap. If the CORESET and/or the SSB following the PDSCH is not transmitted, it may be preferable to schedule the PDSCH transmission to end before the starting symbol of the CORESET and/or the SSB to ensure a gap in which another neighbor BS/UE/node may perform a CAP.

This section proposes a method of performing TDRA for a PDSCH scheduled by a PDCCH in a CORESET, when an SSB/CORESET transmission is supported as illustrated in FIGS. 14 and 15. The TDRA method proposed in this section may be confined to a PDSCH scheduled by CORESET index 0, before SLIV-related (UE-specific) RRC signaling is received. For example, the TDRA method may be applied restrictively to a PDSCH carrying RMSI (referred to as RMSI PDSCH). For convenience, a PDCCH scheduling a RMSI PDSCH is referred to as an RMSI PDCCH.

1) Receiver (Entity A; e.g., UE):

[Case #1-1]

When an RMSI PDCCH is transmitted in the 1-symbol CORESET C1 in FIGS. 14 and 15, the following operations may be performed (S is the index of a starting symbol, L is a length, and E is the index of an ending symbol).
S=1 and L=4/5/6 (E=4/5/6)
S=1, L=6, and E=6 are already included in the default TDRA table 8 (row index=13).
Proposal 1) For S=1, L=4/5, and E=4/5, additional signaling may be required in the default TDRA table 8. It may be regulated that a DMRS is transmitted in symbol #1, symbol #2, or a symbol indicated by dmrs-TypeA-position. An additional DMRS may be transmitted according to L. For example, if L=6 or 7, the additional DMRS may be transmitted in the last symbol or the second last symbol. When it is scheduled that S=1 and L=5 (or 4), a neighbor BS may advantageously attempt/succeed in a CAP in symbol #6 and start to transmit a PDCCH in symbol #7.
S=2 and L=4/5 (E=5/6)
S=2, L=4, and E=5 are already included in the default TDRA table 8 (row index=14).
S=2, L=5, and E=6 are already included in the default TDRA table 8 (row index=5).
S=1 and L=11/12/13 (E=11/12/13)
S=1, L=13, and E=13 are already included in the default TDRA table 8 (row index=12).
Proposal 1-1) For S=1, L=11, and E=11, additional signaling may be required in the default TDRA table 8. It may be regulated that a DMRS is transmitted in symbol #1, symbol #2, or a symbol indicated by dmrs-TypeA-position. When it is scheduled that S=1 and L=11, a neighbor BS may advantageously attempt/succeed in a CAP in symbol #12/13 and start to transmit a PDCCH at the next slot boundary.
S=2 and L=10/11/12 (E=11/12/13)
S=2, L=12, and E=13 are already included in the default TDRA table 8 (row index=12)
Proposal 1-2) For S=2, L=10, and E=11, additional signaling may be required in the default TDRA table 8. It may be regulated that a DMRS is transmitted in symbol #1, symbol #2, or a symbol indicated by dmrs-TypeA-position. When it is scheduled that S=2 and L=10, a neighbor BS may advantageously attempt/succeed in a CAP in symbol #12/13 and start to transmit a PDCCH at the next slot boundary.
S=0 and L=6/7 (E=5/6)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 1-3) For S=0 and L=6, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=0 and L=6, a neighbor BS may advantageously attempt/succeed in a CAP in symbol #6 and start to transmit a PDCCH in symbol #7.

[Case #1-2]

When an RMSI PDCCH is transmitted in the 1-symbol CORESET C2 and the 2-symbol CORESET C3 in FIGS. 14 and 15, the following operations may be performed.
S=2 and L=4/5 (E=5/6)
S=2, L=4, and E=5 are already included in the default TDRA table 8 (row index=14).
S=2, L=5, and E=6 are already included in the default TDRA table 8 (row index=5).
S=2 and L=10/11/12 (E=11/12/13)
S=2, L=12, and E=13 are already included in the default TDRA table 8 (row index=12).
Proposal 1A) For S=2, L=10, and E=11, additional signaling may be required in the default TDRA table 8. It may be regulated that a DMRS is transmitted in symbol #1, symbol #2, or a symbol indicated by dmrs-TypeA-position. When it is scheduled that S=2 and L=10, a neighbor BS may advantageously attempt/succeed in a CAP in symbol #12/13 and start to transmit a PDCCH at the next slot boundary.
S=0 and L=6/7 (E=5/6)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 1B) For S=0 and L=6, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=0 and L=6, a neighbor BS may advantageously attempt/succeed in a CAP in symbol #6 and start to transmit a PDCCH in symbol #7.

[Case #2-1]

When an RMSI PDCCH is transmitted in the 1-symbol CORESET C4 in FIG. 14, the following operations may be performed.
Proposal 2) S=7 and L=4/5/6/7 (E=10/11/12/13)
Additional signaling may be required in the default TDRA table 8. It may be regulated that a DMRS is transmitted in symbol #7, symbol #8, or a symbol indicated by “dmrs-TypeA-position+6”. An additional DMRS may be transmitted according to L. For example, if L=6/7, the additional DMRS may be transmitted in the last symbol or the second last symbol. When it is scheduled that S=7 and L=5/6 (or 4), a neighbor BS may advantageously attempt/succeed in a CAP in symbol #12 and/or symbol #13 and start to transmit a PDCCH at the next slot boundary. Alternatively, when it is scheduled that S=7 and L=7, the corresponding BS may advantageously start to transmit a PDCCH at the next slot boundary without an additional CAP.
S=8 and L=4/5/6 (E=11/12/13)
S=8, L=4, and E=11 are already included in the default TDRA table 8 (row index=16).
S=8, L=5/6, and E=12/13 are additionally required.
Proposal 3) It may be regulated that a DMRS is transmitted in symbol #8 or #9. An additional DMRS may be transmitted according to L. For example, if L=6, the additional DMRS may be transmitted in the last symbol or the second last symbol.
S=6 and L=6/7/8 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 3-1) For S=6 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=6 and L=6/7, a neighbor BS may advantageously attempt/succeed in a CAP in symbol #12 and/or symbol #13 and start to transmit a PDCCH at the next slot boundary. Alternatively, when it is scheduled that S=6 and L=8, the corresponding BS may start to transmit a PDCCH at the next slot boundary without an additional CAP.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 3-2) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may start to transmit a PDCCH at the next slot boundary without an additional CAP.

[Case #2-2]

When an RMSI PDCCH is transmitted in the 1-symbol CORESET C5 and the 2-symbol CORESET C6 in FIG. 14, the following operations may be performed.
S=8 and L=4/5/6 (E=11/12/13)
S=8, L=4, and E=11 are already included in the default TDRA table 8 (row index=16).
S=8, L=5/6, and E=12/13 are additionally required.
Proposal 4) It may be regulated that a DMRS is transmitted in symbol #8 or #9. An additional DMRS may be transmitted according to L. For example, when L=6, the additional DM-RS may be transmitted in the last symbol or the second last symbol.
S=6 and L=6/7/8 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 4-1) For S=6 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=6 and L=6/7, a neighbor BS may advantageously attempt/succeed in a CAP in symbol #12 and/or symbol #13 and start to transmit a PDCCH at the next slot boundary. Alternatively, when it is scheduled that S=6 and L=8, the corresponding BS may advantageously start to transmit a PDCCH at the next slot boundary without an additional CAP.
S=7 and L=5/6 or 7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 4-2) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageously start to transmit a PDCCH at the next slot boundary without an additional CAP.

[Case #3-1]

When an RMSI PDCCH is transmitted in the 1-symbol CORESET C4 in FIG. 15, the following operations may be performed.
S=8 and L=4/5/6 (E=11/12/13)
S=8, L=4, and E=11 are already included in the default TDRA table 8 (row index=16).
S=8, L=5/6, and E=12/13 are additionally required.
Proposal 5) It may be regulated that a DMRS is transmitted in symbol #8 or #9. An additional DMRS may be transmitted according to L. For example, if L=6, the additional DMRS may be transmitted in the last symbol or the second last symbol.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 5-1) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageously start to transmit a PDCCH at the next slot boundary without an additional CAP.

[Case #3-2]

When an RMSI PDCCH is transmitted in the 1-symbol CORESET C5 or the 2-symbol CORESET C6 in FIG. 14, the following operations may be performed.
S=9 and L=4/5 (E=12/13)
S=9, L=4, and E=12 are already included in the default TDRA table 8 (row index=6).
Proposal 6) For S=9, L=5, and E=13, additional signaling may be required in the default TDRA table 8. It may be regulated that a DMRS is transmitted in symbol #9 or #10. When it is scheduled that S=9 and L=5, the corresponding BS may start to transmit a PDCCH at the next slot boundary without an additional CAP.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 6-1) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may start to transmit a PDCCH at the next slot boundary without an additional CAP.

Proposal 7) Invalid codepoints may be produced in the default TDRA table (e.g., Table 8) according to the ending symbol of a CORESET in the above cases. In this regard, depending on a CORESET carrying a PDCCH (or the position of the ending symbol of the CORESET), OPT1) even the same codepoint may be interpreted differently in the default TDRA table (e.g., Table 8) or OPT2) a different default TDRA table may be defined. For example, it may be regulated that upon receipt of a PDCCH in a 1-symbol CORESET of symbol #0 as in Case 1-1, the UE determines that S=1 and L=4/5 in correspondence with row index=14 in Table 8, and upon receipt of a PDCCH in a 1-symbol/2-symbol CORESET ending in symbol #1 as in Case 1-2, the UE determines that S=1 and L=4 in correspondence with row index=14 in Table 8. In another example, row index=1 and row index=12 may be integrated into one state and the proposed S/L values may be added for the remaining states. Herein, it may be regulated that upon receipt of a PDCCH in a 1-symbol CORESET of symbol #0 as in Case 1-1, the UE determines that S=1 and L=13 in correspondence with row index=1 in Table 8, and upon receipt of a PDCCH in a 1-symbol/2-symbol CORESET ending in symbol #1 as in Case 1-2, the UE determines that S=2 and L=12 in correspondence with row index=1 in Table 8.

In another example of OPT1), it may be regulated that S is identified as an offset from the index of the starting/ending symbol of a CORESET or a PDCCH scheduling a PDSCH. For example, when a TDRA entry with S=2 and L=4 is indicated and a PDCCH scheduling a PDSCH is transmitted in a CORESET corresponding to symbol #0/1, the starting symbol index of the PDSCH may be identified as symbol #2 by applying a 2-symbol offset from the starting symbol of the CORESET. Alternatively, when a PDCCH scheduling a PDSCH is transmitted in a CORESET of symbol #6/7, the starting symbol index of the PDSCH may be identified as symbol #8 by applying a 2-symbol offset from the starting symbol of the CORESET.

In another example of OPT1), it may be regulated that when the ending symbol of a PDSCH calculated by S and L exceeds a slot boundary, PDSCH TDRA is processed as invalid, the PDSCH is identified as scheduled in the next slot, not the corresponding slot, or the ending symbol of the PDSCH is interpreted as symbol #13 (or #12 or #11).

Proposal 8) It may be regulated that when the indexes of symbols carrying a PDSCH may not overlap with an SSB (associated with the PDSCH) in the same slot, DMRS transmission in one of the non-overlapped symbols is guaranteed.

2) Transmitter (Entity B, e.g., BS):

[Case #1-1A]

When an RMSI PDCCH is transmitted in the 1-symbol CORESET C1 in FIGS. 14 and 15, the following operations may be performed.
S=1 and L=4/5/6 (E=4/5/6)
S=1, L=6, and E=6 are already included in the default TDRA table 8 (row index=13).
Proposal 1A) S=1, L=4/5, and E=4/5 may be signaled by the BS. For example, S=1, L=4/5, and E=4/5 may be additionally signaled in the default TDRA table 8. It may be regulated that a DMRS is transmitted in symbol #1, symbol #2, or a symbol indicated by dmrs-TypeA-position. An additional DMRS may be transmitted according to L. For example, if L=6 or 7, the additional DMRS may be transmitted in the last symbol or the second last symbol. When it is scheduled that S=1 and L=5 (or 4), a neighbor BS may advantageously attempt/succeed in a CAP in symbol #6 and start to transmit a PDCCH in symbol #7.
S=2 and L=4/5 (E=5/6)
S=2, L=4, and E=5 are already included in the default TDRA table 8 (row index=14).
S=2, L=5, and E=6 are already included in the default TDRA table 8 (row index=5).
S=1 and L=11/12/13 (E=11/12/13)
S=1, L=13, and E=13 are already included in the default TDRA table 8 (row index=12).
Proposal 1A-1) For S=1, L=11, and E=11, additional signaling may be required in the default TDRA table 8. It may be regulated that a DMRS is transmitted in symbol #1, symbol #2, or a symbol indicated by dmrs-TypeA-position. When it is scheduled that S=1 and L=11, a neighbor BS may advantageously attempt/succeed in a CAP in symbol #12/13 and start to transmit a PDCCH at the next slot boundary.
S=2 and L=10/11/12 (E=11/12/13)
S=2, L=12, and E=13 are already included in the default TDRA table 8 (row index=12)
Proposal 1A-2) For S=2, L=10, and E=11, additional signaling may be required in the default TDRA table 8. It may be regulated that a DMRS is transmitted in symbol #1, symbol #2, or a symbol indicated by dmrs-TypeA-position. When it is scheduled that S=2 and L=10, a neighbor BS may advantageously attempt/succeed in a CAP in symbol #12/13 and start to transmit a PDCCH at the next slot boundary.
S=0 and L=6/7 (E=5/6)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 1A-3) For S=0 and L=6, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=0 and L=6, a neighbor BS may advantageously attempt/succeed in a CAP in symbol #6 and start to transmit a PDCCH in symbol #7.

[Case #1-2A]

When an RMSI PDCCH is transmitted in the 1-symbol CORESET C2 or the 2-symbol CORESET C3 in FIGS. 14 and 15, the following operations may be performed.
S=2 and L=4/5 (E=5/6)
S=2, L=4, and E=5 are already included in the default TDRA table 8 (row index=14).
S=2, L=5, and E=6 are already included in the default TDRA table 8 (row index=5).
S=2 and L=10/11/12 (E=11/12/13)
S=2, L=12, and E=13 are already included in the default TDRA table 8 (row index=12).
Proposal 1A-A) For S=2, L=10, and E=11, additional signaling may be required in the default TDRA table 8. It may be regulated that a DMRS is transmitted in symbol #1, symbol #2, or a symbol indicated by dmrs-TypeA-position. When it is scheduled that S=2 and L=10, a neighbor BS may advantageously attempt/succeed in a CAP in symbol #12/13 and start to transmit a PDCCH at the next slot boundary.
S=0 and L=6/7 (E=5/6)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 1A-B) For S=0 and L=6, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=0 and L=6, a neighbor BS may advantageously attempt/succeed in a CAP in symbol #6 and start to transmit a PDCCH in symbol #7.

[Case #2-1A]

When an RMSI PDCCH is transmitted in the 1-symbol CORESET C4 in FIG. 14, the following operations may be performed.
Proposal A2) S=7 and L=4/5/6/7 (E=10/11/12/13)
The BS may perform additional signaling based on the default TDRA table 8. It may be regulated that a DMRS is transmitted in symbol #7, symbol #8, or a symbol indicated by “dmrs-TypeA-position+6”. An additional DMRS may be transmitted according to L. For example, if L=6/7, the additional DMRS may be transmitted in the last symbol or the second last symbol. When it is scheduled that S=7 and L=5/6 (or 4), a neighbor BS may advantageously attempt/succeed in a CAP in symbol #12 and/or symbol #13 and start to transmit a PDCCH at the next slot boundary. Alternatively, when it is scheduled that S=7 and L=7, the corresponding BS may advantageously start to transmit a PDCCH at the next slot boundary without an additional CAP.
S=8 and L=4/5/6 (E=11/12/13)
S=8, L=4, and E=11 are already included in the default TDRA table 8 (row index=16).
S=8, L=5/6, and E=12/13 are additionally required.
Proposal 3A) It may be regulated that a DMRS is transmitted in symbol #8 or #9. An additional DMRS may be transmitted according to L. For example, if L=6, the additional DMRS may be transmitted in the last symbol or the second last symbol.
S=6 and L=6/7/8 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 3A-1) For S=6 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=6 and L=6/7, a neighbor BS may advantageously attempt/succeed in a CAP in symbol #12 and/or symbol #13 and start to transmit a PDCCH at the next slot boundary. Alternatively, when it is scheduled that S=6 and L=8, the corresponding BS may start to transmit a PDCCH at the next slot boundary without an additional CAP.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 3A-2) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageous start to transmit a PDCCH at the next slot boundary without an additional CAP.

[Case #2-2A]

When an RMSI PDCCH is transmitted in the 1-symbol CORESET C5 or the 2-symbol CORESET C6 in FIG. 14, the following operations may be performed.
S=8 and L=4/5/6 (E=11/12/13)
S=8, L=4, and E=11 are already included in the default TDRA table 8 (row index=16).
S=8, L=5/6, and E=12/13 are additionally required.
Proposal 4A) It may be regulated that a DMRS is transmitted in symbol #8 or #9. An additional DMRS may be transmitted according to L. For example, when L=6, the additional DM-RS may be transmitted in the last symbol or the second last symbol.
S=6 and L=6/7/8 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 4A-1) For S=6 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=6 and L=6/7, a neighbor BS may advantageously attempt/succeed in a CAP in symbol #12 and/or symbol #13 and start to transmit a PDCCH at the next slot boundary. Alternatively, when it is scheduled that S=6 and L=8, the corresponding BS may advantageously start to transmit a PDCCH at the next slot boundary without an additional CAP.
S=7 and L=5/6 or 7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 4A-2) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageously start to transmit a PDCCH at the next slot boundary without an additional CAP.

[Case #3A-1]

When an RMSI PDCCH is transmitted in the 1-symbol CORESET C4 in FIG. 15, the following operations may be performed.
S=8 and L=4/5/6 (E=11/12/13)
S=8, L=4, and E=11 are already included in the default TDRA table 8 (row index=16).
S=8, L=5/6, and E=12/13 are additionally required.
Proposal 5A) It may be regulated that a DMRS is transmitted in symbol #8 or #9. An additional DMRS may be transmitted according to L. For example, if L=6, the additional DMRS may be transmitted in the last symbol or the second last symbol.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 5A-1) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageously start to transmit a PDCCH at the next slot boundary without an additional CAP.

[Case #3-2A]

When an RMSI PDCCH is transmitted in the 1-symbol CORESET C5 or the 2-symbol CORESET C6 in FIG. 14, the following operations may be performed.
S=9 and L=4/5/6 (E=12/13)
S=9, L=4, and E=12 are already included in the default TDRA table 8 (row index=6).
Proposal 6A) For S=9, L=S, and E=13, additional signaling may be required in the default TDRA table 8. It may be regulated that a DMRS is transmitted in symbol #9 or #10. When it is scheduled that S=9 and L=S, the corresponding BS may advantageously start to transmit a PDCCH at the next slot boundary without an additional CAP.
S=7 and L=5/6/7 (E=11/12/13)
As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH.
Proposal 6A-1) For S=7 and L=6/7/8, additional signaling may be required in the default TDRA table 8. As mapping type B is configured, a PDSCH may start in a symbol following a configured CORESET (which may include a PDCCH scheduling the PDSCH or which may be configured separately by RRC signaling (e.g., PBCH)), and a DMRS may be mapped to the starting symbol of the PDSCH. When it is scheduled that S=7 and L=6/7, a neighbor BS may advantageously attempt/succeed in a CAP in symbol #12 and/or symbol #13 and start to transmit a PDCCH at the next slot boundary. Alternatively, when it is scheduled that S=7 and L=8, the corresponding BS may advantageously start to transmit a PDCCH at the next slot boundary without an additional CAP.

Proposal 7A) Invalid codepoints may be produced in the default TDRA table (e.g., Table 8) according to the ending symbol of a CORESET in the above cases. In this regard, depending on a CORESET carrying a PDCCH (or the position of the ending symbol of the CORESET), OPT1) signaling may be transmitted so that even the same codepoint is interpreted differently in the default TDRA table (e.g., Table 8) or OPT2) a different default TDRA table may be defined. For example, it may be regulated that when the BS has transmitted a PDCCH in a 1-symbol CORESET of symbol #0 as in Case 1-1, the BS signals S=1 and L=4/5 as S and L values corresponding to row index=14 in Table 8, and when the BS has transmitted a PDCCH in a 1-symbol/2-symbol CORESET ending in symbol #1 as in Case 1-2, the BS signals S=1 and L=4 as S and L values corresponding to row index=14 in Table 8 as is done conventionally. In another example, row index=1 and row index=12 may be integrated into one state and the proposed S/L values may be added for the remaining states. Herein, it may be regulated that when the BS has transmitted a PDCCH in a 1-symbol CORESET of symbol #0 as in Case 1-1, the BS signals S=1 and L=13 as S and L values corresponding to row index=1 in Table 8, and when the BS has transmitted a PDCCH in a 1-symbol/2-symbol CORESET ending in symbol #1 as in Case 1-2, the BS signals S=2 and L=12 as S and L values corresponding to row index=1 in Table 8, as is done conventionally.

In another example of OPT1), it may be regulated that S is identified as an offset from the starting/ending symbol index of a CORESET or a PDCCH scheduling a PDSCH. For example, when a TDRA entry with S=2 and L=4 is indicated and a PDCCH scheduling a PDSCH is transmitted in a CORESET corresponding to symbol #0/1, the starting symbol index of the PDSCH may be identified as symbol #2 by applying a 2-symbol offset from the starting symbol of the CORESET. Alternatively, when a PDCCH scheduling a PDSCH is transmitted in a CORESET corresponding to symbol #6/7, the starting symbol index of the PDSCH may be identified as symbol #8 by applying a 2-symbol offset from the starting symbol of the CORESET.

In another example of OPT1), it may be regulated that when the ending symbol of a PDSCH calculated by S and L exceeds a slot boundary, PDSCH TDRA is processed as invalid, the PDSCH is identified as scheduled in the next slot, not the corresponding slot, or the ending symbol of the PDSCH is interpreted as symbol #13 (or #12 or #11).

Proposal 8A) It may be regulated that when the indexes of symbols carrying a PDSCH may not overlap with an SSB (associated with the PDSCH) in the same slot, DMRS transmission in one of the non-overlapped symbols is guaranteed.

Section 2: Method of Determining Whether SSB is Transmitted

In the unlicensed-band NR, a DL transmission burst which includes at least an SSB burst set and may further include RMSI (=PDCCH+PDSCH), paging, and/or other system information (OSI) may be defined as a discovery reference signal (DRS) (or discovery burst). Because the DRS may be used for a UE performing initial access or a UE performing RRM/RLM measurement, multiple transmission occasions for the DRS may be provided within a predetermined (time) window, in case a CAP is failed. The (time) window may be defined as a DRS transmission window or a DRS measurement timing configuration (DMTC) window. A UE assumes that an SSB transmission in a half-frame occurs within the DMTC window. The DMTC window starts from the first symbol of the first slot of a half-frame, and the duration (i.e., time length) of the DMTC window may be indicated by higher-layer signaling (e.g., RRC signaling). When the duration of the DMTC window is not indicated, the duration of the DMTC window is defined to be equal to the length of a half-frame. The periodicity of the DMTC window is equal to the periodicity of a half-frame for SBS reception.

This section proposes a method of, when a PDSCH is transmitted in a DRS transmission window, a DMTC window, or a slot available for DRS transmission, indicating whether there is a DRS in a slot scheduled for the PDSCH or identifying whether there is a DRS in a slot scheduled for the PDSCH by a UE.

1) Receiver (Entity A; e.g., UE):

[Method #1-1]

For a PDSCH scheduled by a PDCCH in a CORESET associated with an SSB in the same slot, when a (e.g., RMSI PDSCH) TDRA symbol overlaps with another SSB region in the slot, the UE always assumes that another SSB is not transmitted (or is always transmitted).

For example, referring to FIG. 14, when PDSCH TDRA scheduled by a PDCCH transmitted in the 2-symbol CORESET C2 corresponding to SSB #n overlaps with all or a part of symbols #8, #9, #10, and #11, the UE may assume that SSB #n+1 is not transmitted. That is, the UE may assume that the PDSCH is mapped to an RE/RB region overlapping with SSB #n+1.

[Method #1-2]

For a PDSCH scheduled by a PDCCH in a CORESET associated with an SSB in the same slot, when a (e.g., RMSI PDSCH) TDRA symbol overlaps with another SSB region in the slot, it may be signaled by a PBCH whether the UE may assume that another SSB is or is not transmitted.

For example, it may be signaled by a 1-bit field in a PBCH that an SSB not associated with a CORESET is not transmitted in the same slot as carrying the CORESET. Referring to FIG. 14, when PDSCH TDRA scheduled by a PDCCH transmitted in the 2-symbol CORESET C2 corresponding to SSB #n overlaps with all or a part of symbols #8, #9, #10, and #11, the UE may assume that SSB #n+1 is not transmitted. That is, the UE may assume that the PDSCH is mapped to an RE/RB region overlapping with SSB #n+1. In another example, it may be signaled by a 1-bit field in a PBCH that an SSB not associated with a CORESET may be transmitted in the same slot as carrying the CORESET. Referring to FIG. 14, when PDSCH TDRA scheduled by a PDCCH transmitted in the 2-symbol CORESET, C2 corresponding to SSB #n overlaps with all or a part of symbols #8, #9, #10, and #11, the UE may assume that the PDSCH is rate-matched in the region of SSB #n+1. That is, the UE may assume that the PDSCH is not mapped to an RE/RB region overlapping with SSB #n+1.

[Method #1-3]

The indexes of SSBs or beams transmitted in a cell may be signaled by cell-specific (or UE-specific) RRC signaling such as RMSI (on the cell, a PCell, or a PSCell) (e.g., see FIG. 7). Further, when a plurality of SSB transmission candidates may be configured/defined for an SSB corresponding to a specific beam index (or an SSB in a QCL relationship) in a DMTC window, transmission or non-transmission may be commonly (i.e., equally) assumed for all SSB transmission candidates. For example, a plurality of candidate SSB indexes may be configured/defined to correspond to one beam/SSB index, and transmission or non-transmission may be commonly (i.e., equally) assumed for the plurality of candidate SSB indexes corresponding to the same beam/SSB index. The SSB transmission candidates (e.g., SSB transmission positions corresponding to the candidate SSB indexes) may be used to provide a plurality of transmission occasions in case of a CAP failure of the BS.

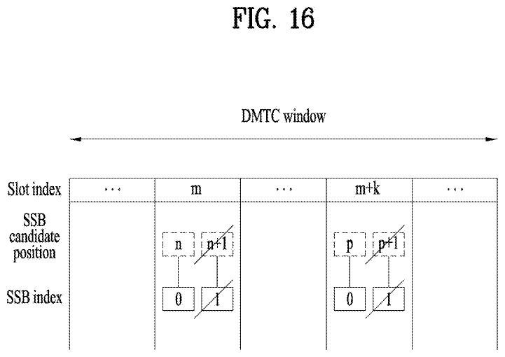

For example, referring to FIG. 16, it may be signaled by bitmap information in RMSI (or UE-specific RRC signaling) that beam index (or SSB index) #0 is transmitted, and beam index #1 is not transmitted. Therefore, an SSB corresponding to SSB index #0 may be transmitted, and an SSB corresponding to SSB index #1 may not be transmitted. For slot #m and slot #m+k in a DMTC window, SSB candidate positions (e.g., SSB candidate position #n/p) in slot #m and slot #m+k may be defined for an SSB corresponding to beam index #0, and SSB candidate positions (e.g., SSB candidate position #n+1/p+1) in slot #m and slot #m+k may be defined for an SSB corresponding to beam index #1. To transmit an SSB corresponding to SSB index #a, the BS may sequentially perform a CAP for a plurality of SSB transmission candidates (or candidate SSBs) corresponding to SSB index #a and transmit the SSB in an SSB transmission candidate for which the CAP is successful. In this case, the CAP/SSB transmission may be dropped in SSB transmission candidate(s) after the SSB transmission candidate in which the SSB is actually transmitted among the plurality of SSB transmission candidates corresponding to SSB index #a.

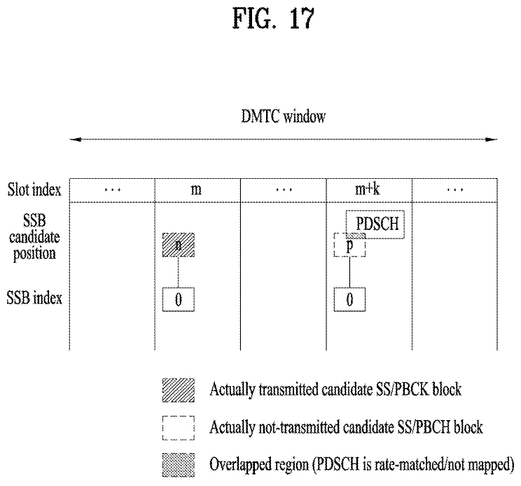

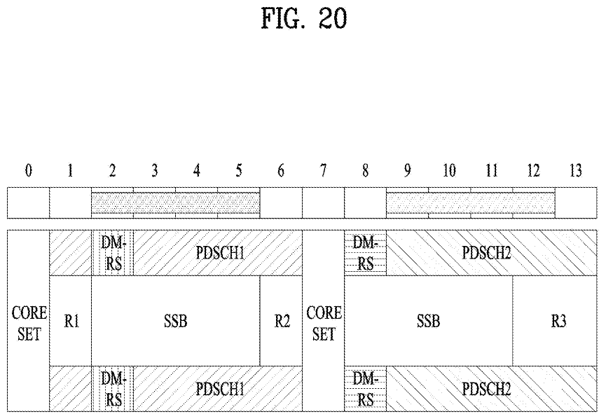

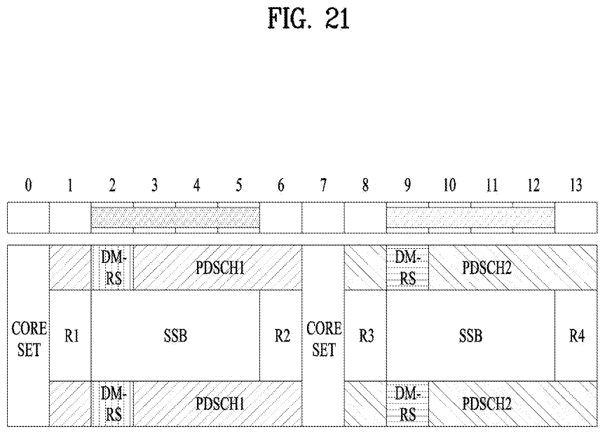

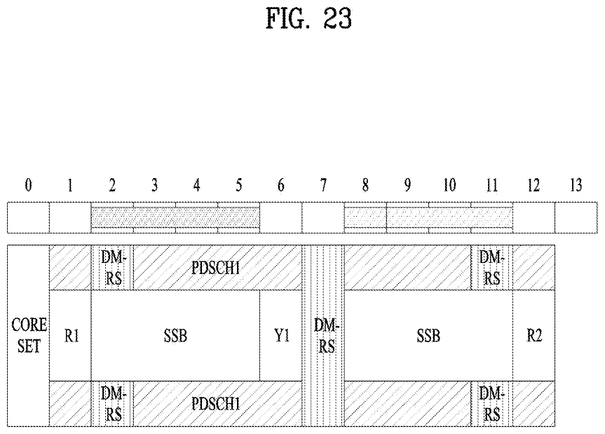

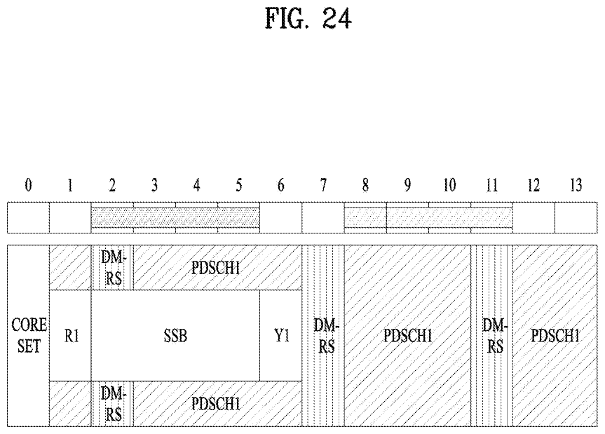

As illustrated in FIG. 17, when the UE receives a PDSCH in slot #m and/or slot #m+k, if a PDSCH TDRA result overlaps with an SSB (transmission candidate) corresponding to beam index #0, the UE may assume that the PDSCH is rate-matched in a corresponding SSB region (e.g., an overlapped SSB region). According to this method, transmission or non-transmission may be assumed commonly for all of a plurality of SSB transmission candidates corresponding to the same SSB/beam index. The UE may determine whether an SSB is actually transmitted in a corresponding SSB transmission candidate by attempting SSB detection in each SSB transmission candidate. However, attempting to detect an SSB for all SSB transmission candidates at the UE may increase UE complexity. When the UE has an error in the SSB detection, an error may also occur to PDSCH signal processing (e.g., decoding). Accordingly, as transmission or non-transmission is assumed commonly (i.e., equally) for all of a plurality of SSB transmission candidates corresponding to the same SSB/beam index, when a PDSCH overlaps with an SSB transmission candidate, the PDSCH may be rate-matched for the overlapped region irrespective of whether an SSB is actually transmitted/discovered in the corresponding SSB transmission candidate. Herein, rate-matching includes encoding a PDSCH in consideration of total PDSCH transmission resources including an overlapped region, without mapping the PDSCH to the overlapped region among the total PDSCH transmission resources. That is, the PDSCH is not mapped to the overlapped region. Accordingly, the UE may receive/decode the PDSCH. The overlapped region may refer to overlapped physical resources (e.g., RE or RB) in the time-frequency domain (i.e., only an actually overlapped region) or overlapped resources (e.g., RE or RB) in the frequency domain as illustrated in FIGS. 20 to 24 (i.e., a region which is not actually overlapped but overlapped on the frequency axis). In the latter case, for details of PDSCH mapping/rate-matching, see section 3.

On the other hand, since it has been signaled that beam index #1 is not transmitted, the UE may assume that the PDSCH is mapped to the corresponding SSB region in receiving the PDSCH in slot #m and/or slot #m+k, even though the PDSCH TDRA result overlaps with the SSB (transmission candidate) corresponding to beam index #1.

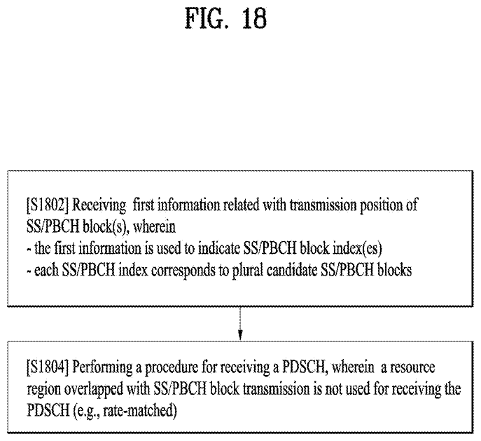

FIG. 18 illustrates an exemplary PDSCH reception process according to this method. Referring to FIG. 18, a UE may receive first information related to a transmission position of an SS/PBCH block (S1802). The first information may be used to indicate at least one SS/PBCH block index related to at least one actually transmitted SS/PBCH block within a time window (e.g., a DMTC window). Further, the first information may be received by cell-specific (or UE-specific) RRC signaling such as RMSI. Subsequently, the UE may perform a procedure for receiving a PDSCH (S1804). The PDSCH may be received in a resource region overlapping with an SS/PBCH block transmission based on resource allocation of the PDSCH overlapping with the SS/PBCH block transmission. The resource allocation of the PDSCH may indicate/mean a time-frequency resource region allocated by scheduling information (e.g., FDRA or TDRA) of a corresponding PDCCH. Further, each SS/PBCH block index may correspond to a plurality of candidate SS/PBCH blocks, and the SS/PBCH block transmission may include all candidate SS/PBCH blocks corresponding to at least one SS/PBCH block index according to the first information. That is, transmission or non-transmission may be assumed commonly (i.e., equally) for all of the plurality of SSB transmission candidates corresponding to the same SSB/beam index.

The PDSCH may be received in all allocated resource region based on the resource allocation of the PDSCH not overlapping with the SS/PBCH block transmission (e.g., not overlapping with any candidate SS/PBCH block). Further, an SS/PBCH block may actually be transmitted only in a part of a plurality of candidate SS/PBCH blocks corresponding to the respective SS/PBCH block indexes. Further, the PDSCH may not be received in any resource area overlapping with the plurality of candidate SS/PBCH blocks irrespective of whether the SS/PBCH block is transmitted in at least one of the plurality of candidate SS/PBCH blocks. Further, the wireless communication system may include a wireless communication system operating in an unlicensed band (e.g., a shared spectrum band, U-band, or UCell).

[Method #1-4]

DCI scheduling a PDSCH in slot #m may indicate whether the PDSCH is rate-matched with an SSB in the slot.

For example, the presence or absence of each SSB in the slot may be indicated by a separate 2-bit field introduced in DCI. In another example, when it may be identified by separate RRC signaling that the (maximum) number of SSBs transmittable in a specific slot is 1, the presence or absence of an SSB in the slot may be indicated by 1 bit, instead of 2 bits. In another example, when an SSB associated with a CORESET carrying a PDCCH is transmitted in the same slot as a PDSCH scheduled by the PDCCH, it may be assumed that the SSB associated with the CORESET is always transmitted (or is not transmitted), and the presence or absence of another SSB not associated with the CORESET in the slot may be indicated just by 1 bit. In another example, when an SSB associated with a CORESET carrying a PDCCH is transmitted in the same slot as a PDSCH scheduled by the PDCCH, the presence or absence of the associated SSB may be indicated just by 1 bit, and it may be assumed that another SSB not associated with the CORESET is always transmitted (or is not transmitted) in the slot. In another example, when an SSB associated with a CORESET carrying a PDCCH is transmitted in the same slot as a PDSCH scheduled by the PDCCH, determination of the presence or absence of the SSB depends on whether the UE discovers the SSB (without separate signaling) (i.e., when the UE discovers the SSB, it is assumed that the PDSCH is rate-matched without being transmitted in the SSB region), and the presence or absence of another non-associated SSB in the slot may be indicated just by 1 bit.

When a separate 1-bit or 2-bit field is introduced to DCI to indicate whether an SSB is transmitted, the field may be valid only in a CORESET which may schedule a PDSCH in a slot available for SSB transmission (e.g., in slots within a DMTC window or when K0=1, in only slots within the DMTC window, starting from one slot before the DMTC window), and may be predefined as a specific state (e.g., 00) or reserved in the other slots/CORESETs.

Alternatively, a plurality of rate-matching patterns may be preconfigured by RRC signaling, and specific pattern(s) out of the rate-matching pattern(s) may be dynamically indicated by DCI. For example, all or a part of the rate-matching pattern(s) may be indicated by DCI in consideration of rate-matching with an SSB. Further, the rate-matching pattern for which the SSB is considered may be valid only in a CORESET which may schedule a PDSCH in a slot available for SSB transmission (e.g., sin lots in the DMTC window, or if K0=1, in slots within the DMTC window, starting from one slot before the DMTC window), and may be linked to another rate-matching pattern or reserved in the other slots/CORESETs.

2) Transmitter (Entity B; e.g., BS):

[Method #1-1A]

For a PDSCH scheduled by a PDCCH in a CORESET associated with an SSB in the same slot, when a (e.g., RMSI PDSCH) TDRA symbol overlaps with another SSB region in the slot, another SSB may not be transmitted to the UE (or any DL signal may not be transmitted to the UE in other SSB regions).

For example, referring to FIG. 14, when PDSCH TDRA scheduled by a PDCCH transmitted in a 2-symbol CORESET, C2 corresponding to SSB #n overlaps with all or a part of symbols #8, 9, 10, and 11, the BS may map the PDSCH to an RE/RB region overlapped with SSB #n+1.

[Method #1-2A]

For a PDSCH scheduled by a PDCCH in a CORESET associated with an SSB in the same slot, when a (e.g., RMSI PDSCH) TDRA symbol overlaps with another SSB region in the slot, it may be signaled by a PBCH whether the UE may assume that another SSB is or is not transmitted.

For example, it may be signaled by a 1-bit field in a PBCH that an SSB not associated with a CORESET is not transmitted in the same slot as carrying the CORESET. Referring to FIG. 14, when PDSCH TDRA scheduled by a PDCCH transmitted in a 2-symbol CORESET, C2 corresponding to SSB #n overlaps with all or a part of symbols #8, 9, 10, and 11, the BS may ensure that SSB #n+1 is not transmitted. That is, the BS may map the PDSCH to an RE/RB region overlapping with SSB #n+1. In another example, it may be signaled by the 1-bit field in the PBCH that an SSB not associated with a CORESET is transmitted in the same slot as carrying the CORESET. Referring to FIG. 14, when PDSCH TDRA scheduled by a PDCCH transmitted in a 2-symbol CORESET, C2 corresponding to SSB #n overlaps with all or a part of symbols #8, 9, 10, and 11, the BS may make sure for the UE to assume that the PDSCH is rate-matched in the region of SSB #n+1. That is, the BS may not map the PDSCH to an RE/RB region overlapped with SSB #n+1.

[Method #1-3A]

The indexes of SSBs or beams transmitted in a cell may be signaled by cell-specific (or UE-specific) RRC signaling such as RMSI (on the cell, a PCell, or a PSCell) (e.g., see FIG. 7). Further, when a plurality of SSB transmission candidates may be configured/defined for an SSB corresponding to a specific beam index (or an SSB in a QCL relationship with the SSB) in a DMTC window, transmission or non-transmission may be commonly (i.e., equally) assumed for all SSB transmission candidates. For example, a plurality of candidate SSB indexes are configured/defined to correspond to one beam/SSB index, and transmission or non-transmission may be commonly (i.e., equally) assumed for the plurality of candidate SSB indexes corresponding to the same beam/SSB index. The SSB transmission candidates (e.g., SSB transmission positions corresponding to the candidate SSB indexes) may be used to provide a plurality of transmission occasions in case a CAP failure of the BS.

For example, referring to FIG. 16, it may be signaled by bitmap information in RMSI (or UE-specific RRC signaling) that beam index (or SSB index) #0 is transmitted, and beam index #1 is not transmitted. Therefore, an SSB corresponding to SSB index #0 may be transmitted, and an SSB corresponding to SSB index #1 may not be transmitted. For slot #m and slot #m+k in a DMTC window, SSB candidate positions (e.g., SSB candidate position #n/p) in slot #m and slot #m+k may be defined for an SSB corresponding to beam index #0, and SSB candidate positions (e.g., SSB candidate position #n+1/p+1) in slot #m and slot #m+k may be defined for an SSB corresponding to beam index #1. To transmit an SSB corresponding to SSB index #a, the BS may sequentially perform a CAP for a plurality of SSB transmission candidates (or candidate SSBs) corresponding to SSB index #a and transmit the SSB in an SSB transmission candidate for which the CAP is successful. In this case, the CAP/SSB transmission may be dropped in SSB transmission candidate(s) after the SSB transmission candidate in which the SSB is actually transmitted among the plurality of SSB transmission candidates corresponding to SSB index #a.

As illustrated in FIG. 17, when the BS transmits a PDSCH in slot #m and/or slot #m+k, if a PDSCH TDRA result overlaps with an SSB (transmission candidate) corresponding to beam index #0, the BS may make sure for UE to assume that the PDSCH is rate-matched for a corresponding SSB region (e.g., an overlapped SSB region). According to this method, transmission or non-transmission may be assumed commonly for all of a plurality of SSB transmission candidates corresponding to the same SSB/beam index. The UE may determine whether an SSB is actually transmitted in a corresponding SSB transmission candidate by attempting SSB detection in each SSB transmission candidate. However, attempting to detect an SSB for all SSB transmission candidates at the UE may increase UE complexity. When the UE has an error in the SSB detection, an error may occur to PDSCH signal processing (e.g., decoding). Accordingly, as common (i.e., equal) assumption of transmission or non-transmission is ensured for all of a plurality of SSB transmission candidates corresponding to the same SSB/beam index, when a PDSCH overlaps with an SSB transmission candidate, the PDSCH may be rate-matched for the overlapped region irrespective of whether an SSB is actually transmitted/discovered in a corresponding SSB transmission candidate. Herein, rate-matching includes encoding a PDSCH in consideration of total PDSCH transmission resources including an overlapped region, but not mapping the PDSCH to the overlapped region among the total PDSCH transmission resources. That is, the PDSCH is not mapped to the overlapped region. Accordingly, the UE may receive/decode the PDSCH. The overlapped region may refer to overlapped physical resources (e.g., RE or RB) in the time-frequency domain (i.e., only an actually overlapped region) or overlapped resources (e.g., RE or RB) in the frequency domain as illustrated in FIGS. 20 to 24 (i.e., a region which is not actually overlapped but overlapped on the frequency axis). In the latter case, for details of PDSCH mapping/rate-matching, see section 3.

On the other hand, since it has been signaled that beam index #1 is not transmitted, the BS may make sure for the UE to assume that the PDSCH is mapped to the corresponding SSB region in transmitting the PDSCH in slot #m and/or slot #m+k, even though the PDSCH TDRA result overlaps with the SSB (transmission candidate) corresponding to beam index #1.

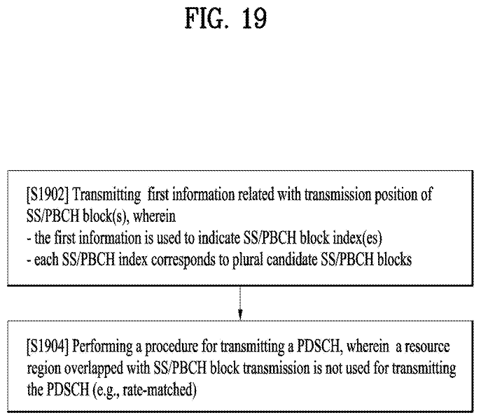

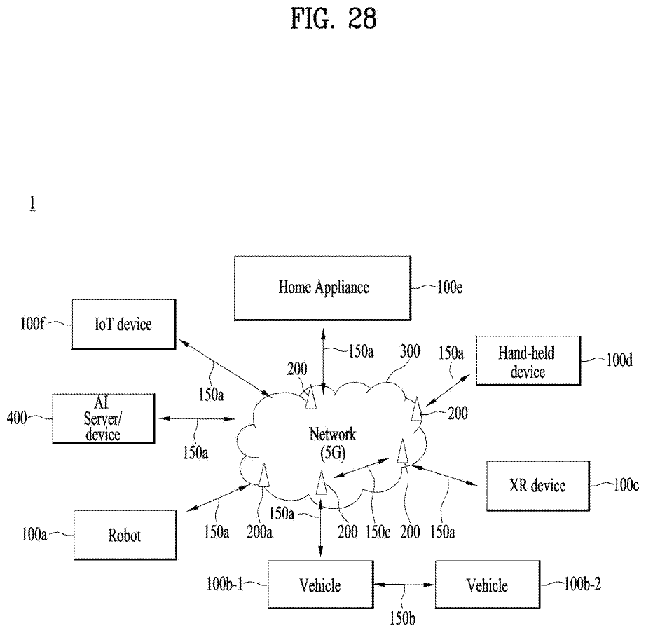

FIG. 19 illustrates an exemplary PDSCH reception process according to this method. Referring to FIG. 28, a UE may transmit first information related to a transmission position of an SS/PBCH block (S1902). The first information may be used to indicate at least one SS/PBCH block index related to at least one actually transmitted SS/PBCH block in a time window (e.g., a DMTC window). Further, the first information may be received by cell-specific (or UE-specific) RRC signaling such as RMSI. Subsequently, the BS may perform a process for transmitting a PDSCH (S1904). The PDSCH may be transmitted in a resource area overlapping with a SS/PBCH block transmission based on resource allocation of the PDSCH overlapping with the SS/PBCH block transmission. The resource allocation of the PDSCH may indicate/mean a time-frequency resource region allocated by scheduling information (e.g., FDRA or TDRA) in a corresponding PDCCH. Further, each SS/PBCH block index may correspond to a plurality of candidate SS/PBCH blocks, and the SS/PBCH block transmission may include all candidate SS/PBCH blocks corresponding to at least one SS/PBCH block index according to the first information. That is, transmission or non-transmission may be assumed commonly (i.e., equally) for all of the plurality of SSB transmission candidates corresponding to the same SSB/beam index.

The PDSCH may be transmitted in all allocated resource areas based on the resource allocation of the PDSCH not overlapping with the SS/PBCH block transmission (e.g., not overlapping with any candidate SS/PBCH block). Further, an SS/PBCH block may actually be transmitted only in a part of a plurality of candidate SS/PBCH blocks corresponding to the respective SS/PBCH block indexes. Further, the PDSCH may not be received in any resource area overlapping with the plurality of candidate SS/PBCH blocks irrespective of whether the SS/PBCH block is transmitted in at least one of the plurality of candidate SS/PBCH blocks. Further, the wireless communication system may include a wireless communication system operating in an unlicensed band (e.g., a shared spectrum band, U-band, or UCell).

[Method #1-4A]

DCI scheduling a PDSCH in slot #m may indicate whether the PDSCH is rate-matched with an SSB in the slot.

For example, the presence or absence of each SSB in the slot may be indicated by a separate 2-bit field introduced in DCI. In another example, when it may be identified by separate RRC signaling that the (maximum) number of SSBs transmittable in a specific slot is 1, the presence or absence of an SSB in the slot may be indicated by 1 bit, instead of 2 bits. In another example, when an SSB associated with a CORESET carrying a PDCCH is transmitted in the same slot as a PDSCH scheduled by the PDCCH, it may be assumed that the SSB associated with the CORESET is always transmitted (or is not transmitted), and the presence or absence of another SSB not associated with the OCRESET in the slot may be indicated just by 1 bit. In another example, when an SSB associated with a CORESET carrying a PDCCH is transmitted in the same slot as a PDSCH scheduled by the PDCCH, the presence or absence of the associated SSB may be indicated just by 1 bit, and it may be assumed that another SSB not associated with the CORESET is always transmitted in the slot. In another example, when an SSB associated with a CORESET carrying a PDCCH is transmitted in the same slot as a PDSCH scheduled by the PDCCH, determination of the presence or absence of the SSB depends on whether the UE discovers the SSB (without separate signaling) (i.e., when the UE discovers the SSB, it is assumed that the PDSCH is rate-matched without being transmitted in the SSB region), and the presence or absence of another non-associated SSB in the slot may be indicated just by 1 bit.

When a separate 1-bit or 2-bit field is introduced to DCI to indicate whether an SSB is transmitted, the field may be valid only in a CORESET which may schedule a PDSCH in a slot available for SSB transmission (e.g., slots within a DMTC window or when K0=1, slots within the DMTC window, starting from one slot before the DMTC window), and may be predefined as a specific state (e.g., 00) or reserved in the other slots/CORESETs.

Alternatively, a plurality of rate-matching patterns may be preconfigured by RRC signaling, and specific pattern (s) out of the rate-matching pattern(s) may be dynamically indicated by DCI. For example, all or a part of the rate-matching pattern(s) may be indicated by DCI in consideration of rate-matching with an SSB. Further, the rate-matching pattern for which the SSB is considered may be valid only in a CORESET which may schedule a PDSCH in a slot available for SSB transmission (e.g., slots in the DMTC window, or if K0=1, slots in the DMTC window, starting from one slot before the DMTC window), and may be linked to another rate-matching pattern or reserved in the other slots/CORESETs.

Section 3: PDSCH Mapping Method

A PDSCH rate-matching method related to a UE, which has recognized or received information indicating whether an SSB exists in a slot scheduled for a PDSCH according to the proposed method of Section 2, is proposed.

1) Receiver (Entity A; e.g., UE):

[Method #2-1]

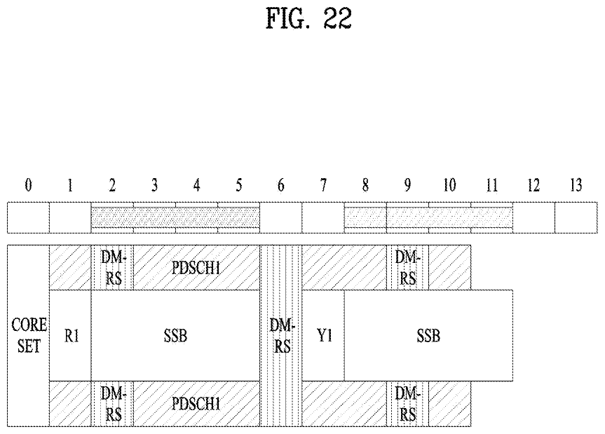

When an SSB to be transmitted between two SSBs is recognized, PDSCH resources may be allocated to overlap with an SSB in the time/frequency domain, as illustrated in FIGS. 20 to 24. A PDSCH may be mapped to an area not overlapping with the SSB in the frequency domain, and it may be signaled whether data is transmitted in overlapped areas (e.g., R1/R2/R3/R4). Upon receipt of signaling indicating that data is transmitted in all or part of the areas (e.g., R1/R2/R3/R4) overlapping with the SSB in the frequency domain, the UE may perform PDSCH decoding in the signaled area based on channel estimation of a PBCH DMRS and/or a PDCCH DMRS (or a closer DMRS between the PBCH DMRS and the PDCCH DMRS). To succeed in the PDSCH decoding in the signaled area, the UE may assume that the PDSCH DMRS and the PBCH DMRS and/or the PDCCH DMRS use the same antenna port (or are placed in the QCL relationship). Further, when a PDSCH DMRS corresponding to the frequency area of Y1 exists in nearby X symbols (e.g., X=1) as in the Y1 area of FIGS. 22, 23 and 24, it may be assumed that the PDSCH is always transmitted without additional signaling or it may be signaled whether data is transmitted as in the areas R1/R2/R3/R4.

2) Transmitter (Entity B):

[Method #2-1A]

When an SSB to be transmitted between two SSBs is recognized, PDSCH resources may be allocated to overlap with an SSB in the time/frequency domain. A PDSCH may be mapped to an area not overlapping with the SSB in the frequency domain, and it may be signaled whether data is transmitted in overlapped areas (e.g., R1/R2/R3/R4). When signaling indicating that data is transmitted in all or a part of the areas (e.g., R1/R2/R3/R4) overlapping with the SSB in the frequency domain is received, the BS may assume that PDSCH decoding is performed in the signaled area based on channel estimation of a PBCH DMRS and/or a PDCCH DMRS (or a closer DMRS between the PBCH DMRS and the PDCCH DMRS). For success in the PDSCH decoding in the signaled area, the BS may ensure use (or the QCL relationship) of the same antenna port for the PDSCH DMRS and the PBCH DMRS and/or the PDCCH DMRS. Further, when a PDSCH DMRS corresponding to the frequency area of Y1 exists in nearby X symbols (e.g., X=1) as in the Y1 area of FIGS. 22, 23 and 24, it may be assumed that the PDSCH is always transmitted without additional signaling or it may be signaled whether data is transmitted as for the areas R1/R2/R3/R4.

While the proposed method in this section is based on the assumption of the specific SBS transmission patterns and the specific PDSCH TDRA illustrated in FIGS. 20 to 24, the method may be extended to the SSB transmission pattern illustrated in FIG. 15, and also different PDSCH TDRA.

Section 4: PDSCH Processing Time

In PDSCH mapping type B of Table 5, a PDSCH processing time (particularly, d_1,1) is determined according to the transmission duration of a PDSCH (i.e., the number of symbols in the PDSCH). The PDSCH processing time may be a minimum time required for the UE to process the PDSCH. In 3GPP Rel-15 NR, the number of symbols in a PDSCH for PDSCH mapping type B is limited to 2/4/7. However, PDSCH mapping type B with an additional number of symbols as well as 2/4/7 symbols may be introduced to an NR system operating in an unlicensed band.

In this section, a method of setting PDSCH processing times (particularly, d_1,1) corresponding to various PDSCH transmission durations is proposed.

1) Receiver (Entity A; e.g., UE):

[Method #3-1]

For UE capability 1 (e.g., see Table 6), d_1,1 may be determined according to the number L of symbols in PDSCH mapping type B, as follows. That is, when a UE which has reported or applies UE capability 1 receives PDSCH mapping type B, d_1,1 may be configured as follows.
For L>7 (e.g., L=8, 9, 10, . . . , 14), d_1,1=0
For 4≤L≤7, d_1,1=7-L
For L=3,
Alt.1: d_1,1=4
Alt.2: d_1,1=3+d (where d may be the number of symbols overlapped between a PDCCH and a scheduled PDSCH).
Alt.3: d_1,1=3+max{d−(L−2),0} (where d may be the number of symbols overlapped between a PDCCH and a scheduled PDSCH, and may also be applied when L is 2). When the overlapped PDCCH belongs to a 3-symbol CORESET and the PDCCH and the CORESET start in the same symbol, d_1,1=4.
Alt.4: d_1,1=2+d (where d may be the number of symbols overlapped between a PDCCH). When the overlapped PDCCH belongs to a 3-symbol CORESET and the PDCCH and the CORESET start in the same symbol, d_1,1=4.

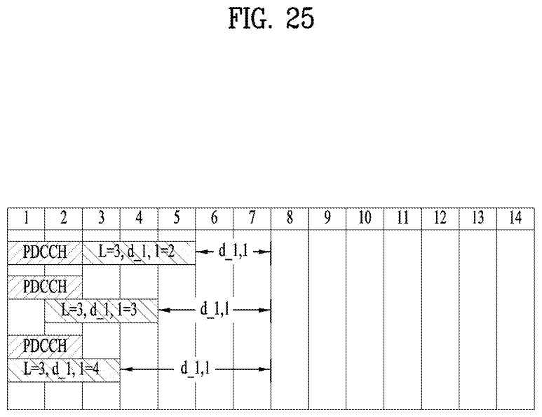

FIG. 25 illustrates Alt.4 for L=3. A PDCCH decoding time spanning at least 7 symbols from the starting symbol of a PDCCH may be guaranteed, and it may be considered that a UE processing time for DMRS-based channel estimation, PDSCH decoding, and HARQ-ACK generation starts after the PDCCH decoding time.

[Method #3-2]

For UE capability 2 (e.g., see Table 6), d_1,1 may be determined according to the number L of symbols in PDSCH mapping type B, as follows. That is, when a UE which has reported or applies UE capability 2 receives PDSCH mapping type B, d_1,1 may be configured as follows.
For L≥7 (e.g., L=8, 9, 10, . . . , 14), d_1,1=0
For 5≤L≤6, (A different Alt may be applied depending on whether L=5 or L=6).
Alt.1: d_1,1=0
Alt.2: d_1,1=d (where d may be the number of symbols overlapped between a PDCCH and a scheduled PDSCH).
Alt.3: d_1,1=max{d−(L−4),0} (where d may be the number of symbols overlapped between a PDCCH and a scheduled PDSCH).
For L=3,
Alt.1: d_1,1=d (where d may be the number of symbols overlapped between a PDCCH and a scheduled PDSCH).
Alt.2: d_1,1=max{d−(L−2),0} (where d may be the number of symbols overlapped between a PDCCH and a scheduled PDSCH).
Alt.3: d_1,1=1+d (where d may be the number of symbols overlapped between a PDCCH and a scheduled PDSCH).

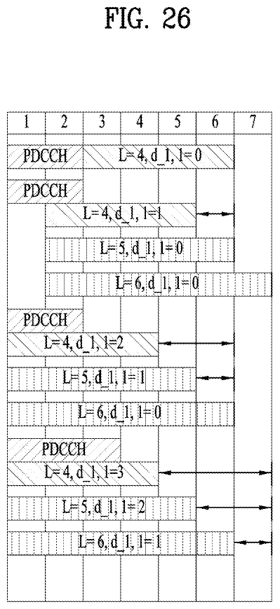

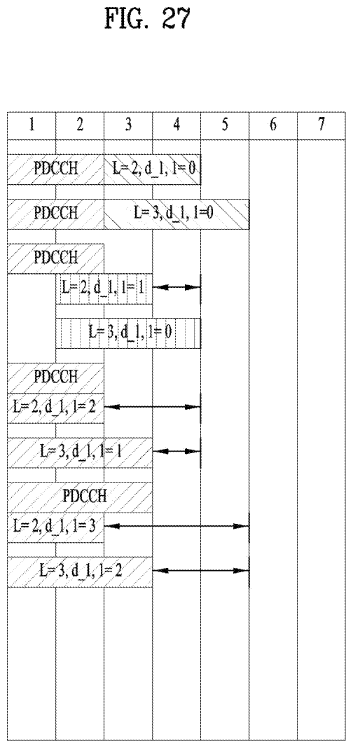

FIG. 26 illustrates Alt. 3 for L=5 or 6. A PDCCH decoding time spanning at least 4 symbols from the starting symbol of a PDCCH may be guaranteed, and it may be considered that a UE processing time for DMRS-based channel estimation, PDSCH decoding, and HARQ-ACK generation starts after the PDCCH decoding time. FIG. 27 illustrates Alt. 2 for L=3. A PDCCH decoding time spanning at least 2 symbols from the starting symbol of a PDCCH may be guaranteed, and it may be considered that a UE processing time for DMRS-based channel estimation, PDSCH decoding, and HARQ-ACK generation starts after the PDCCH decoding time.

2) Transmitter (Entity B; e.g., BS):

[Method #3-1A]

For UE capability 1 (e.g., see Table 6), d_1,1 may be determined according to the number L of symbols in PDSCH mapping type B, as follows. That is, the BS may indicate an HARQ-ACK reporting time, considering that when a UE which has reported or applies UE capability 1 receives PDSCH mapping type B, d_1,1 may be configured as follows.
For L>7 (e.g., L=8, 9, 10, . . . , 14), d_1,1=0
For 4≤L≤7, d_1,1=7−L
For L=3,
Alt.1: d_1,1=4
Alt.2: d_1,1=3+d (where d may be the number of symbols overlapped between a PDCCH and a scheduled PDSCH).
Alt.3: d_1,1=3+max{d−(L−2),0} (where d may be the number of symbols overlapped between a PDCCH and a scheduled PDSCH, and may also be applied when L is 2). When the overlapped PDCCH belongs to a 3-symbol CORESET and the PDCCH and the CORESET start in the same symbol, d_1,1=4.
Alt.4: d_1,1=2+d (where d may be the number of symbols overlapped between a PDCCH). When the overlapped PDCCH belongs to a 3-symbol CORESET and the PDCCH and the CORESET start in the same symbol, d_1,1=4.

[Method #3-2A]

For UE capability 2 (e.g., see Table 6), d_1,1 may be determined according to the number L of symbols in PDSCH mapping type B, as follows. That is, when a UE which has reported or applies UE capability 2 receives PDSCH mapping type B, d_1,1 may be configured as follows.
For L≥7 (e.g., L=8, 9, 10, . . . , 14), d_1,1=0
For 5≤L≤6, (A different Alt may be applied depending on whether L=5 or L=6).
Alt.1: d_1,1=0
Alt.2: d_1,1=d (where d may be the number of symbols overlapped between a PDCCH and a scheduled PDSCH).
Alt.3: d_1,1=max{d−(L−4),0} (where d may be the number of symbols overlapped between a PDCCH and a scheduled PDSCH).
For L=3,
Alt.1: d_1,1=d (where d may be the number of symbols overlapped between a PDCCH and a scheduled PDSCH).
Alt.2: d_1,1=max{d−(L−2),0} (where d may be the number of symbols overlapped between a PDCCH and a scheduled PDSCH).
Alt.3: d_1,1=1+d (where d may be the number of symbols overlapped between a PDCCH and a scheduled PDSCH).

According to the above proposals, when a UE receives a PDSCH (e.g., a PDSCH carrying RMSI) before receiving RRC configuration information, resources may efficiently be configured for CORESET and/or SSB transmission and PDSCH mapping information in an unlicensed band may be indicated to the UE. Since an SSB may be transmitted in a slot other than a specific slot by a CAP, other PDSCHs may also be transmitted and received efficiently based on a method of recognizing whether an SSB is transmitted in corresponding slot(s) and an associated PDSCH mapping method.

The various descriptions, functions, procedures, proposals, methods, and/or operational flowcharts proposals of the present disclosure described above in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 28 illustrates a communication system 1 applied to the present disclosure.

Referring to FIG. 28, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

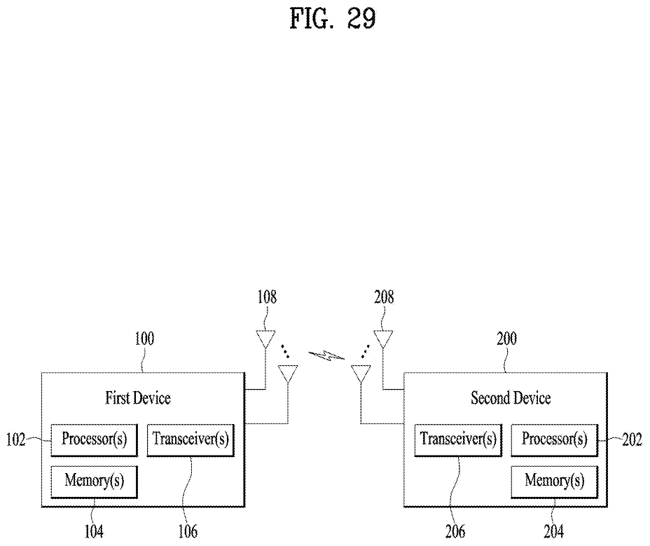

FIG. 29 illustrates wireless devices applicable to the present disclosure.

Referring to FIG. 29, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 28.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

In the present disclosure, at least one memory (e.g., 104 or 204) may store instructions or programs which, when executed, cause at least one processor operably coupled to the at least one memory to perform operations according to some embodiments or implementations of the present disclosure.

In the present disclosure, a computer-readable storage medium may store at least one instruction or computer program which, when executed by at least one processor, causes the at least one processor to perform operations according to some embodiments or implementations of the present disclosure.

In the present disclosure, a processing device or apparatus may include at least one processor and at least one computer memory coupled to the at least one processor. The at least one computer memory may store instructions or programs which, when executed, cause the at least one processor operably coupled to the at least one memory to perform operations according to some embodiments or implementations of the present disclosure.

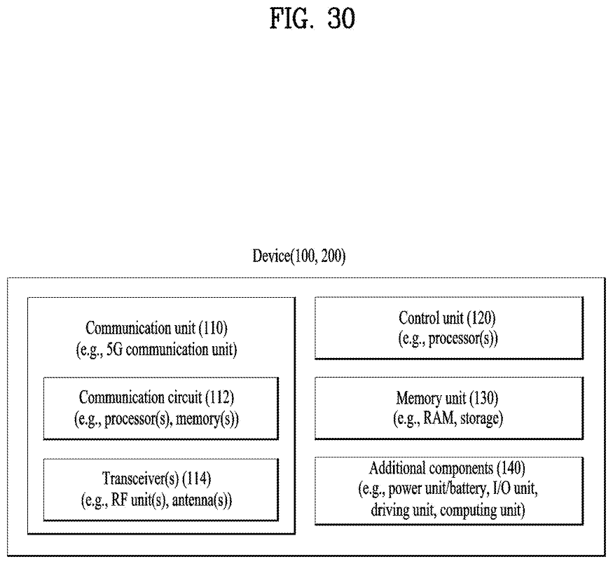

FIG. 30 illustrates another example of a wireless device applied to the present disclosure. The wireless device may be implemented in various forms according to a use-case/service (refer to FIG. 28).

Referring to FIG. 30, wireless devices 100 and 200 may correspond to the wireless devices 100 and 200 of FIG. 29 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 29. For example, the transceiver(s) 114 may include the one or more transceivers 106 and 206 and/or the one or more antennas 108 and 208 of FIG. 29. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 28), the vehicles (100b-1 and 100b-2 of FIG. 28), the XR device (100c of FIG. 28), the hand-held device (100d of FIG. 28), the home appliance (100e of FIG. 28), the IoT device (100f of FIG. 28), a digital broadcast terminal, a hologram device, a public safety device, an MTC device, a medicine device, a fintech device (or a finance device), a security device, a climate/environment device, the AI server/device (400 of FIG. 28), the BSs (200 of FIG. 28), a network node, etc. The wireless device may be used in a mobile or fixed place according to a use-example/service.

In FIG. 30, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

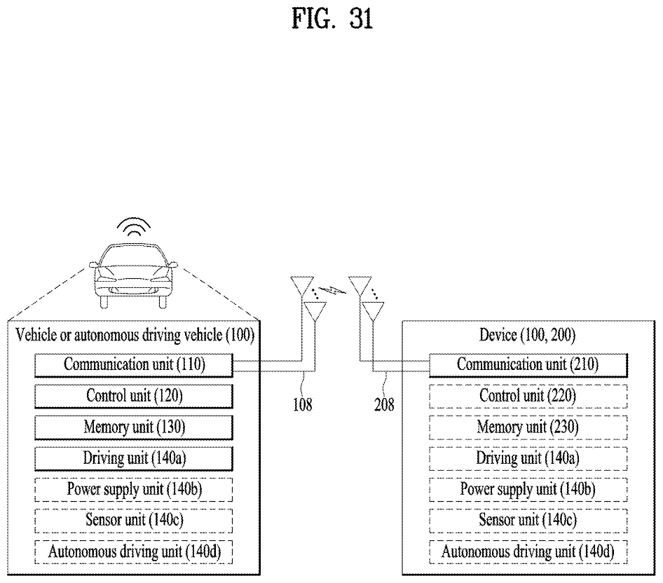

FIG. 31 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 31, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 30, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features can be implemented in a form failing to be combined with other elements or features. Moreover, it is able to implement an embodiment of the present disclosure by combining elements and/or features together in part. A sequence of operations explained for each embodiment of the present disclosure can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The present disclosure is applicable to UEs, eNBs or other apparatuses of a wireless mobile communication system.

What is claimed is:

1. A method of receiving data by a user equipment (UE) in a wireless communication system, the method comprising:
receiving first information related with Synchronization Signal/Physical broadcast channel (SS/PBCH) block position, wherein the first information is used to indicate at least one SS/PBCH block index; and
performing a procedure for receiving a Physical Downlink Shared Channel (PDSCH),
wherein, based on a resource allocation of the PDSCH overlapping with SS/PBCH block transmission, the PDSCH is not received on a resource region overlapping with the SS/PBCH block transmission,
wherein the SS/PBCH block transmission includes all candidate SS/PBCH blocks corresponding to at least one SS/PBCH block index according to the first information, and each SS/PBCH block index corresponds to a plurality of candidate SS/PBCH blocks in Quasi-Co-Located (QCL) relationship on an unlicensed band.

2. The method according to claim 1, wherein based on the resource allocation of the PDSCH not overlapping with the SS/PBCH block transmission, the PDSCH is received in all allocated resource region.

3. The method according to claim 1, wherein an SS/PBCH block is actually transmitted only in a part of the plurality of candidate SS/PBCH blocks corresponding to each SS/PBCH block index.

4. The method according to claim 1, wherein the PDSCH is not received in any resource region overlapping with the plurality of candidate SS/PBCH blocks irrespective of whether an SS/PBCH block is actually transmitted in at least one of the plurality of candidate SS/PBCH blocks.

5. A user equipment (UE) used in a wireless communication system, the UE comprising:
at least one processor; and
at least one computer memory operably coupled to the at least one processor and, when executed, causing the at least one processor to perform operations,
wherein the operations include:
receiving first information related with Synchronization Signal/Physical broadcast channel (SS/PBCH) block position, wherein the first information is used to indicate at least one SS/PBCH block index; and
performing a procedure for receiving a Physical Downlink Shared Channel (PDSCH), and
wherein, based on a resource allocation of the PDSCH overlapping with SS/PBCH block transmission, the PDSCH is not received on a resource region overlapping with the SS/PBCH block transmission,
wherein the SS/PBCH block transmission includes all candidate SS/PBCH blocks corresponding to at least one SS/PBCH block index according to the first information, and each SS/PBCH block index corresponds to a plurality of candidate SS/PBCH blocks in Quasi-Co-Located (QCL) relationship on an unlicensed band.

6. The UE according to claim 5, wherein based on the resource allocation of the PDSCH not overlapping with the SS/PBCH block transmission, the PDSCH is received in all allocated resource region.

7. The UE according to claim 5, wherein an SS/PBCH block is actually transmitted only in a part of the plurality of candidate SS/PBCH blocks corresponding to each SS/PBCH block index.

8. The UE according to claim 5, wherein the PDSCH is not received in any resource region overlapping with the plurality of candidate SS/PBCH blocks irrespective of whether an SS/PBCH block is actually transmitted in at least one of the plurality of candidate SS/PBCH blocks.

9. An apparatus for a user equipment (UE), comprising:
at least one processor; and
at least one computer memory operably coupled to the at least one processor and, when executed, causing the at least one processor to perform operations,
wherein the operations include:
receiving first information related with Synchronization Signal/Physical broadcast channel (SS/PBCH) block position, wherein the first information is used to indicate at least one SS/PBCH block index; and
performing a procedure for receiving a Physical Downlink Shared Channel (PDSCH), and
wherein based on a resource allocation of the PDSCH overlapping with SS/PBCH block transmission, the PDSCH is not received on a resource region overlapping with the SS/PBCH block transmission,
wherein the SS/PBCH block transmission includes all candidate SS/PBCH blocks corresponding to at least one SS/PBCH block index according to the first information, and each SS/PBCH block index corresponds to a plurality of candidate SS/PBCH blocks in Quasi-Co-Located (QCL) relationship on an unlicensed band.

10. The apparatus according to claim 9, wherein based on the resource allocation of the PDSCH not overlapping with the SS/PBCH block transmission, the PDSCH is received in all allocated resource region.

11. The apparatus according to claim 9, wherein an SS/PBCH block is actually transmitted only in a part of the plurality of candidate SS/PBCH blocks corresponding to each SS/PBCH block index.

12. The apparatus according to claim 9, wherein the PDSCH is not received in any resource region overlapping with the plurality of candidate SS/PBCH blocks irrespective of whether an SS/PBCH block is actually transmitted in at least one of the plurality of candidate SS/PBCH blocks.
